(19) United States
(12) Patent Application Publication
(10) Pub. No.: US 2022/0110387 A1
(43) Pub. Date: Apr. 14, 2022

(54) PERSONAL PROTECTIVE EQUIPMENT

(71) Applicant: Ross David DETTORRE, IRVINE, CA (US)

(72) Inventor: Ross David DETTORRE, IRVINE, CA (US)

(21) Appl. No.: 17/490,275

(22) Filed: Sep. 30, 2021

Related U.S. Application Data
(60) Provisional application No. 63/204,555, filed on Oct. 9, 2020.

(51) Int. Cl. A41D 13/11; B01D 46/00; A62B 23/02

(52) U.S. Cl. CPC A41D 13/1184; B01D 2265/021; A62B 23/025; B01D 46/0004

(57) ABSTRACT

The present invention discloses a combination of detachably integrated mask and a detachably integrated face shield.

### CROSS-REFERENCE TO RELATED APPLICATIONS

This Application claims the benefit of priority of co-pending U.S. Utility Provisional Patent Application No. 63/204,555, filed 9 Oct. 2020, the entire disclosure of which is expressly incorporated by reference in its entirety herein.

All documents mentioned in this specification are herein incorporated by reference to the same extent as if each individual document was specifically and individually indicated to be incorporated by reference.

It should be noted that throughout the disclosure, where a definition or use of a term in any incorporated document(s) is inconsistent or contrary to the definition of that term provided herein, the definition of that term provided herein applies and the definition of that term in the incorporated document(s) does not apply.

### BACKGROUND OF THE INVENTION

### Field of the Invention

One or more embodiments of the present invention relate to a Personal

Protective Equipment (PPE) and, more particularly, to a detachably integrated mask and face shield combination.

### Description of Related Art

Conventional Personal Protective Equipment (PPE) are well known and have been in use for a number of years. Most known PPEs may be comprised of a separate mask and a separate face shield.

Regrettably, a majority of the people tend to purchase the PPE mask but not the face shield, which leaves them vulnerable to infectious diseases through the eye. Studies have shown that the eye (which a face shield can protect) is a potential route for the Wuhan coronavirus transmission and infection. In other words, Wuhan coronavirus may be transmitted through the eye.

Accordingly, in light of the current state of the art and the drawbacks to current PPEs mentioned above, a need exists for a single personal protective equipment that would provide both respiratory and ocular protection against transmission of infectious diseases. Further, a need exists for a single personal protective equipment that would provide both respiratory and ocular protection against transmission of infectious diseases and further, enable use of different types of filters.

### BRIEF SUMMARY OF THE INVENTION

A non-limiting, exemplary aspect of an embodiment of the present invention provides personal protective equipment, comprising:
a detachably integrated mask and face shield.

Another non-limiting, exemplary aspect of an embodiment of the present invention provides personal protective equipment, comprising:

a detachably integrated mask and face shield, with interchangeable filters.

These and other features and aspects of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” may be used to mean “serving as an example, instance, or illustration,” but the absence of the term “exemplary” does not denote a limiting embodiment. Any embodiment described as “exemplary” is not necessarily to be construed as preferred or advantageous over other embodiments. In the drawings, like reference character(s) present corresponding part(s) throughout.

FIGS. 1A to 1C are non-limiting exemplary illustrations of a fully assembled personal protective equipment (PPE) in accordance with one or more embodiments of the present invention;

FIGS. 2A to 2C are non-limiting exemplary exploded view illustrations of the various components of PPE shown in FIGS. 1A to 2C in accordance with one or more embodiments of the present invention;

FIGS. 3A to 3F are non-limiting exemplary illustrations of a shield of PPE shown in FIGS. 1A to 2C in accordance with one or more embodiments of the present invention;

FIGS. 4A to 4I are non-limiting exemplary illustrations of a headrest of PPE shown in FIGS. 1A to 3F in accordance with one or more embodiments of the present invention;

FIGS. 5A to 5G are non-limiting exemplary illustrations of a respirator of PPE shown in FIGS. 1A to 4I in accordance with one or more embodiments of the present invention;

FIGS. 6A to 6H are non-limiting exemplary illustrations of a filter of PPE shown in FIGS. 1A to 5G in accordance with one or more embodiments of the present invention (FIG. 6E is a bottom view and 6G is top view);

FIGS. 7A to 7G are non-limiting exemplary illustrations of a filter housing cover of PPE shown in FIGS. 1A to 6H in accordance with one or more embodiments of the present invention;

FIGS. 8A to 8I-3 are non-limiting exemplary illustrations of cooperative working relationship between respirator, filter housing, filter, and filter housing cover of respirator assembly of PPE shown in FIGS. 1A to 7G, including a non-limiting, exemplary method of detachable connectivity thereof in accordance with one or more embodiments of the present invention;

FIGS. 9A to 9J are non-limiting exemplary illustrations of a seal member of PPE shown in FIGS. 1A to 8I-3 in accordance with one or more embodiments of the present invention;

FIGS. 10A to 10C are non-limiting exemplary illustrations of an earpiece of PPE shown in FIGS. 1A to 9J in accordance with one or more embodiments of the present invention; and

FIGS. 11A to 11V are non-limiting, exemplary illustrations of a PPE in accordance with an embodiment of the present invention, with interchangeable filter member.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

It is to be appreciated that certain features of the invention, which are, for clarity, described in the context of separate embodiments, may also be provided in combination in a single embodiment. Conversely, various features of the invention that are, for brevity, described in the context of a single embodiment may also be provided separately or in any suitable sub-combination or as suitable in any other described embodiment of the invention. Stated otherwise, although the invention is described below in terms of various exemplary embodiments and implementations, it should be understood that the various features and aspects described in one or more of the individual embodiments are not limited in their applicability to the particular embodiment with which they are described, but instead can be applied, alone or in various combinations, to one or more of the other embodiments of the invention.

One or more embodiments of the present invention define the phrase “medical grade” in accordance with its ordinary meaning in the medical art. For example, a medical grade matter or material are those that are biocompatible to living systems.

One or more embodiments of the present invention may use the phrase “form factor” as the physical size and or shape of various members and or components of the one or more embodiments of the PPE of the present invention.

One or more embodiments of the present invention provide a single personal protective equipment that provides both respiratory and ocular protection against transmission of infectious diseases, while allowing use of different types of filters.

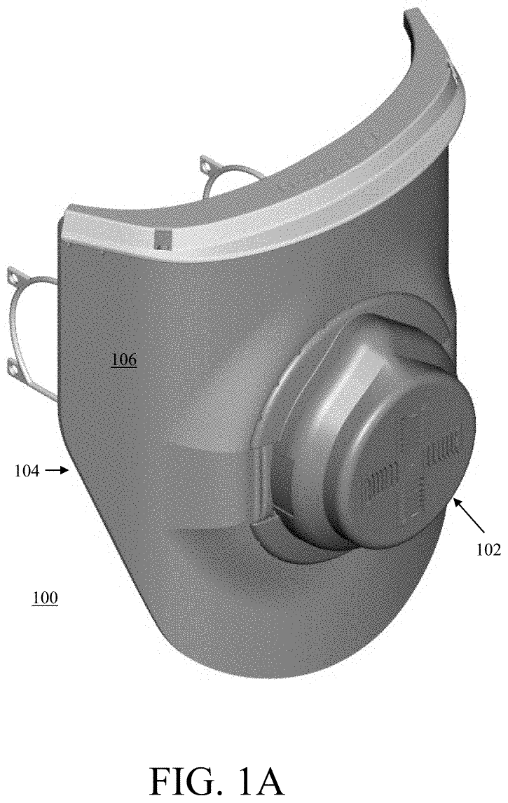

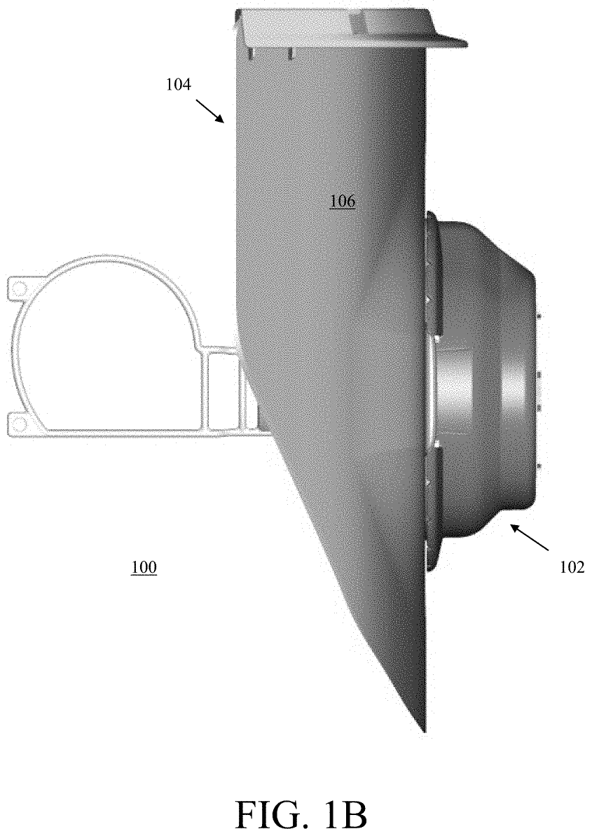

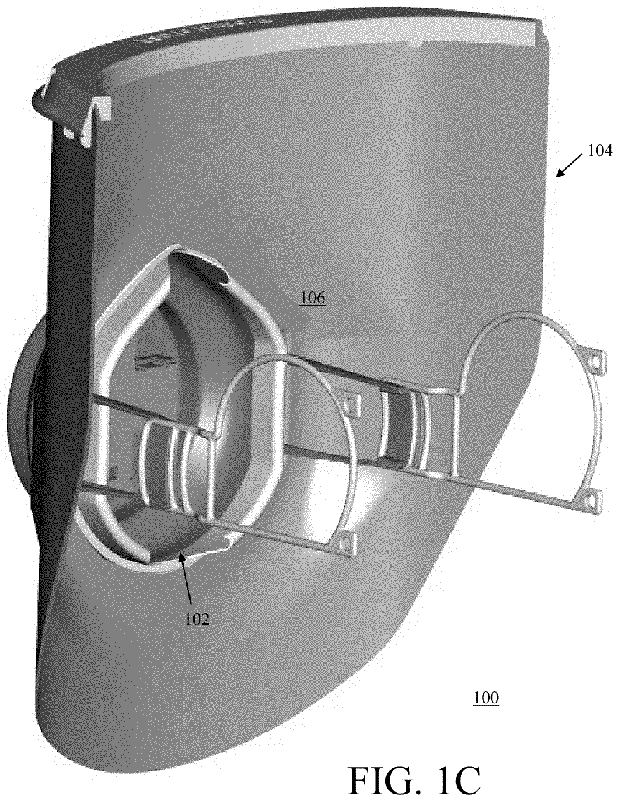

FIGS. 1A to 1C are non-limiting exemplary illustrations of a fully assembled personal protective equipment (PPE) in accordance with one or more embodiments of the present invention. As illustrated, PPE 100 is comprised of a detachably integrated mask 102 and face shield 104, which provides respiratory and ocular protection against transmission of infectious diseases.

As illustrated in FIGS. 1A to 1C, when fully assembled, face shield 106 is of sufficient size to cover a front side of the face from the top of the forehead to below the chin, and laterally, covers the temple of the face, reaching near the ears. Mask 102 fully seals around a mouth/nose of a user and as further detailed below, includes a High Efficiency Particulate Air (HEPA) filter. Accordingly, PPE 100 provides full respiratory and ocular protection against transmission of infectious diseases.

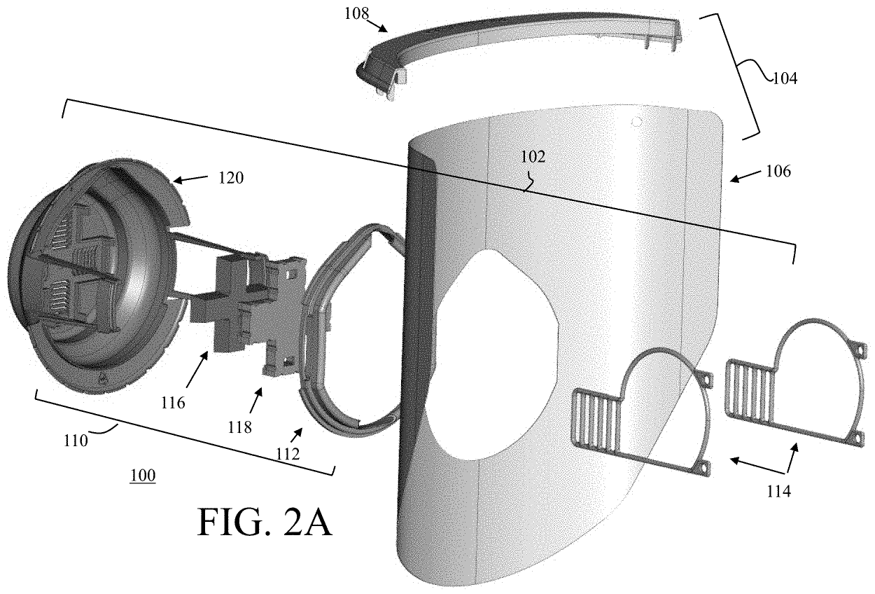

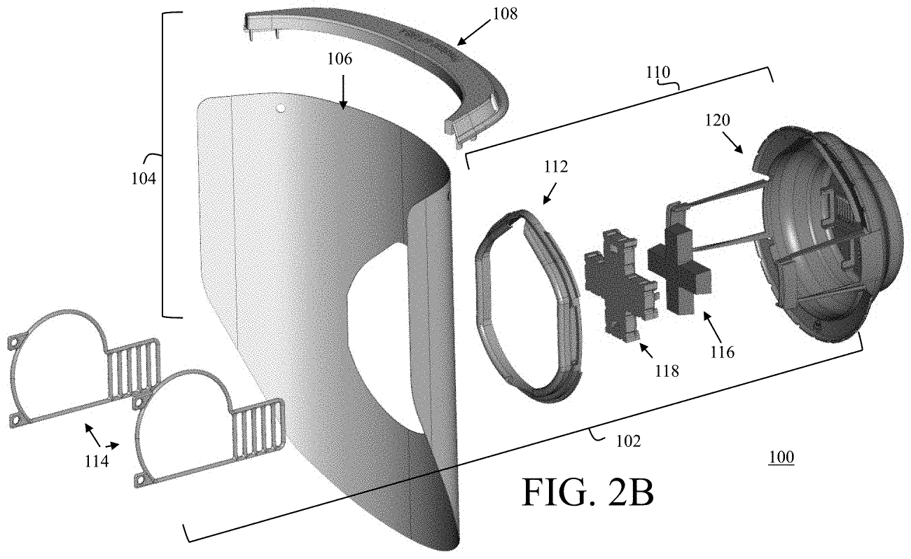

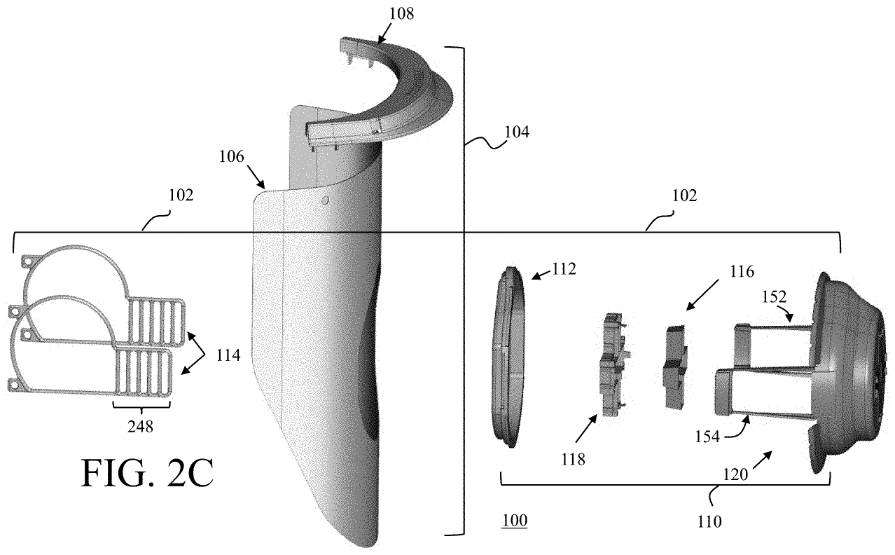

FIGS. 2A to 2C are non-limiting exemplary exploded view illustrations of the various components of PPE shown in FIGS. 1A to 2C in accordance with one or more embodiments of the present invention. The exploded views shown in FIGS. 2A to 2C illustrate disassembled, separated components that show the cooperative working relationship, orientation, positioning, and exemplary manner of assembly of the various components of PPE 100 in accordance with one or more embodiments of the present invention, with each component detailed below.

As illustrated in FIGS. 1A to 2C, PPE 100 is comprised of detachably integrated mask 102 and face shield 104 combination. Face shield 104 is comprised of a shield 106 and a headrest 108. The mask 102 is comprised of a respirator assembly 110, which is comprised of a medical grade material that may be cleaned and reused.

Respirator assembly 110 of mask 102 is comprised of a respirator 120, filter 116, and a filter housing cover 11, and seal member 112. Respirator 120 may be comprised of medical grade plastic that may be cleaned and reused. Seal member 112 may be made from a medical grade silicone that may be cleaned and reused, and a pair of earpieces 114 that are also comprised of medical grade silicone that may be cleaned and reused.

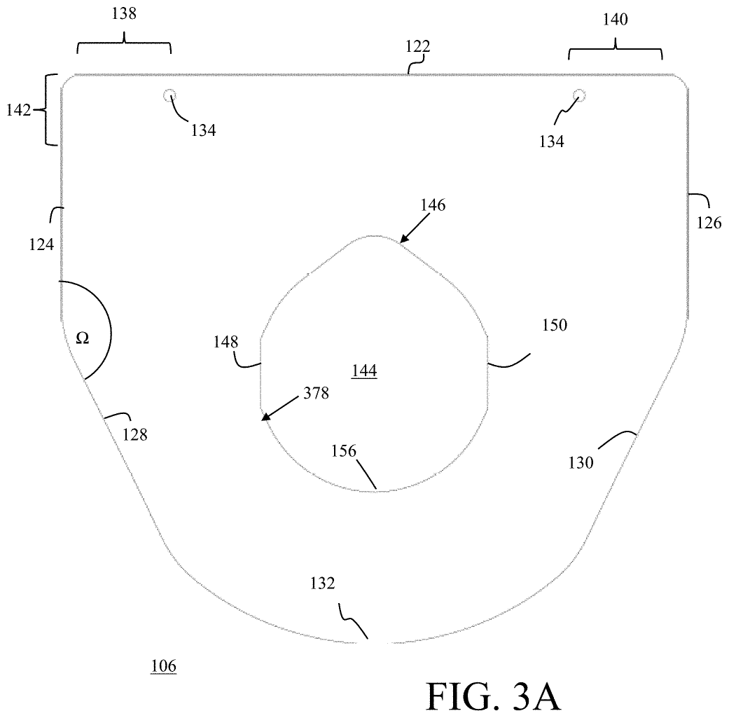

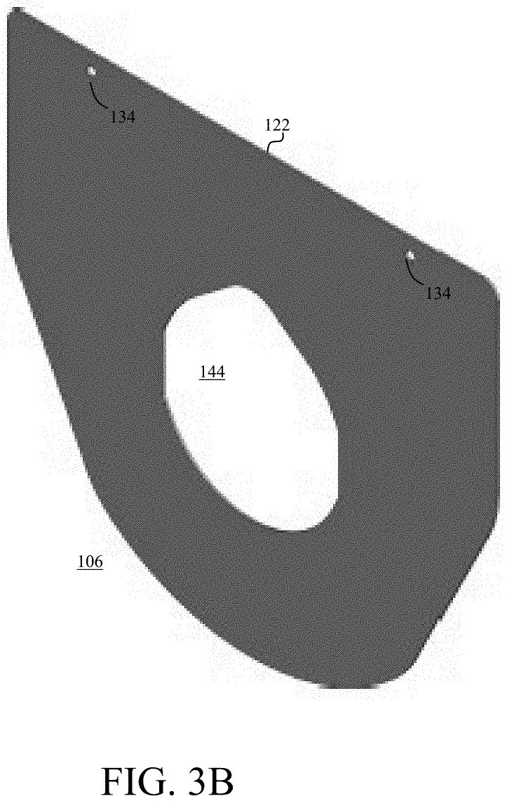

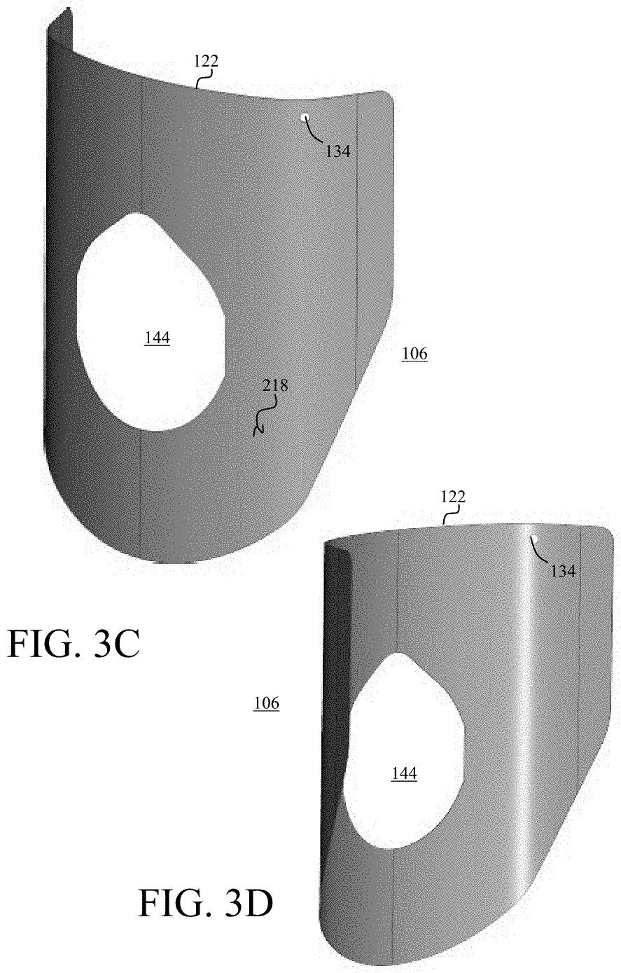

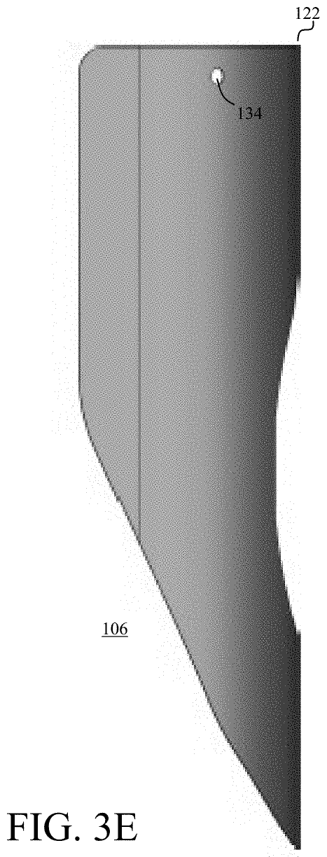

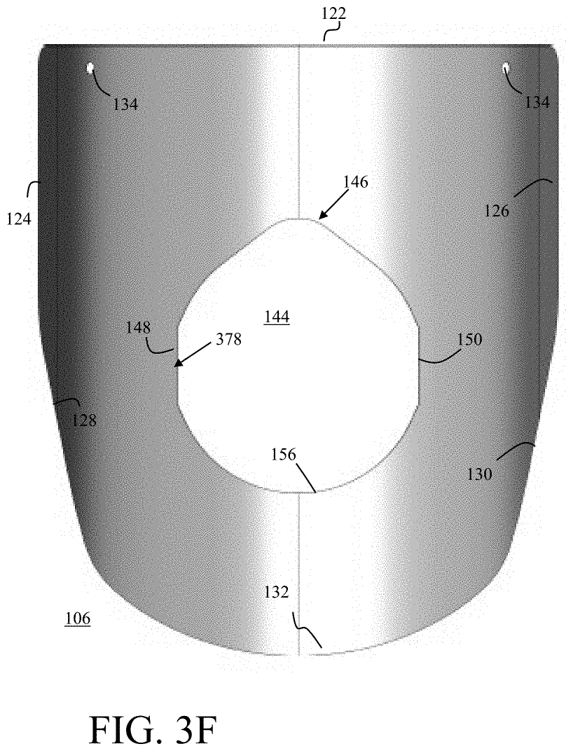

FIGS. 3A to 3F are non-limiting exemplary illustrations of a shield of PPE shown in FIGS. 1A to 2C in accordance with one or more embodiments of the present invention. As illustrated in FIGS. 1A to 3F, shield 106 is comprised of a flat, clear and transparent, medical grade material, non-limiting, non-exhaustive examples of material used may include polyethylene terephthalate (PET or PETE), polyethylene terephthalate GLYCOL (PET-G), acetate, polycarbonate sheets etc. Shield 106 may have a thickness of about 0.005″-0.010″. Shield 106 is flat for ease of shipment in bulk and is easily flexed to be bent into an arc configuration for assembly with headrest 108.

Shield 106 is laterally symmetrical, and includes a top periphery edge 122 oriented horizontally that engages with headrest 108. Further included are lateral edges 124 and 126 that oriented perpendicular to top periphery edge 122.

Shield 106 also includes angled lateral edges 128 and 130 that are oriented at an angle Ω in relation to lateral edges 124 and 126 and top periphery edge 122, that taper and converge to form a curved bottom periphery edge 132.

Angled lateral edges 128 and 130 are angled to provide a relief (a free space) that allow for a free 180-degree lateral rotation of the head without shield 106 accidentally striking or hitting the shoulders. Curved bottom periphery edge 132 allows for full flexion of the head while continuing to provide full protection when head is at extension position.

As further illustrated, shield 106 further includes lateral openings 134 that are located at lateral distal sections 138 and 140, near forehead section 142 of shield 106, near top periphery edge 122.

Shield 106 further includes a mask opening 144 adapted to be aligned with nose and mouth. Mask opening 144 is laterally symmetrical and is comprised of a periphery 378 having a nose relief portion 146, interlocking lateral sides 148 and 150 that snap underneath base ends 236 (at the living hinges 158) of temples 152 and 154 of respirator 120 of respirator assembly 110, and a mouth relief portion 156.

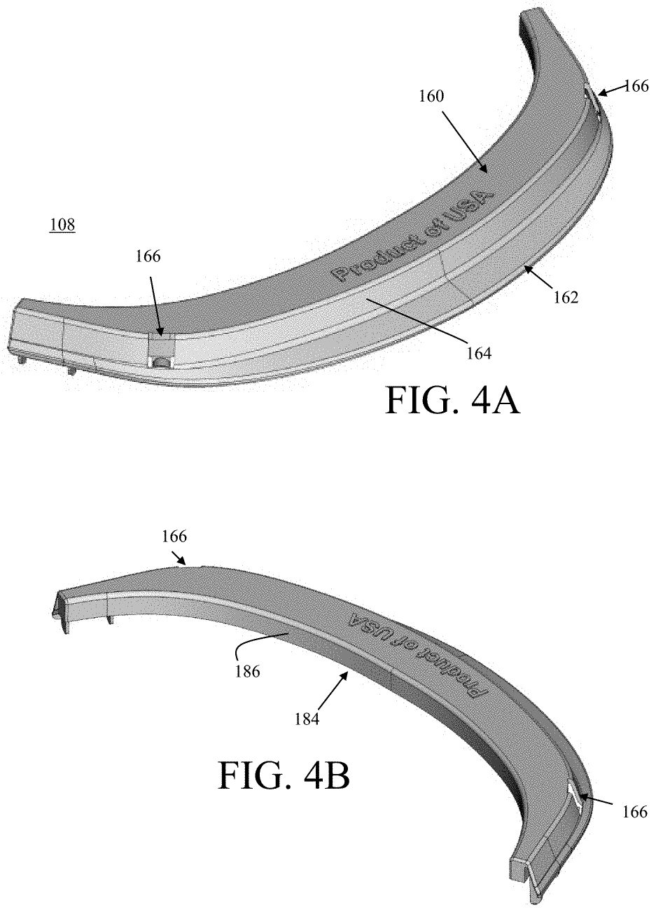

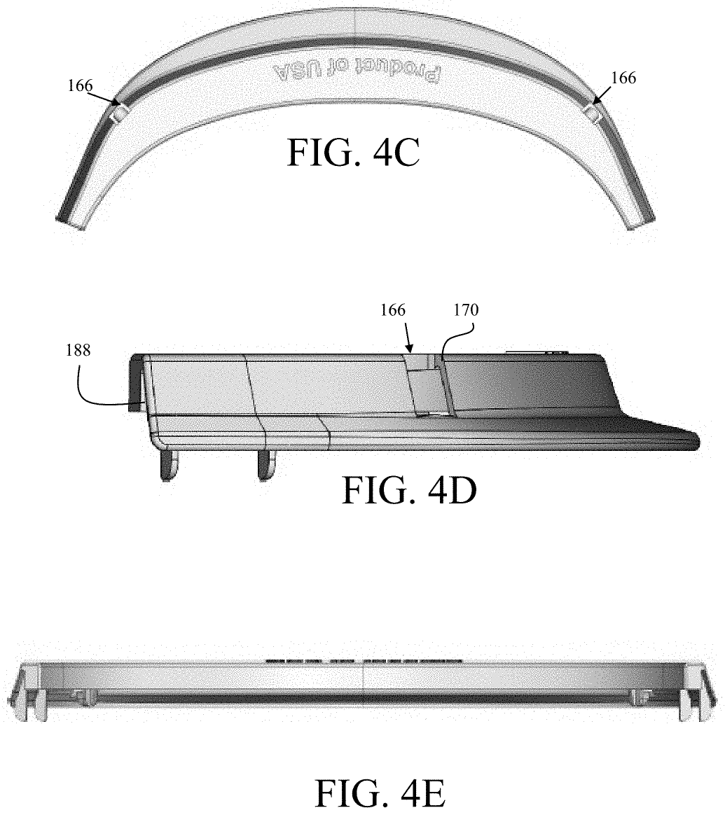

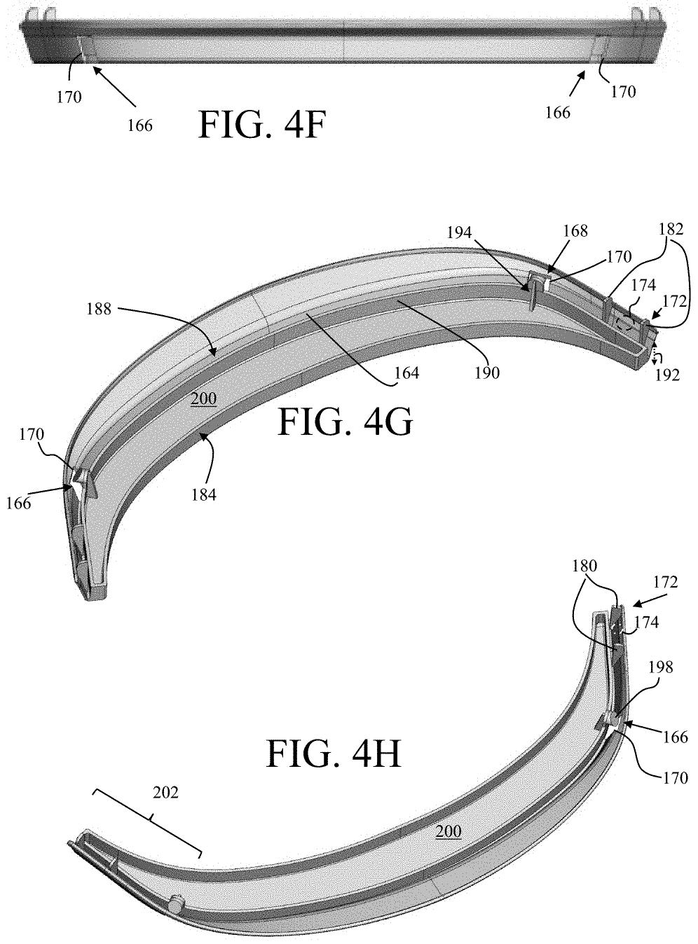

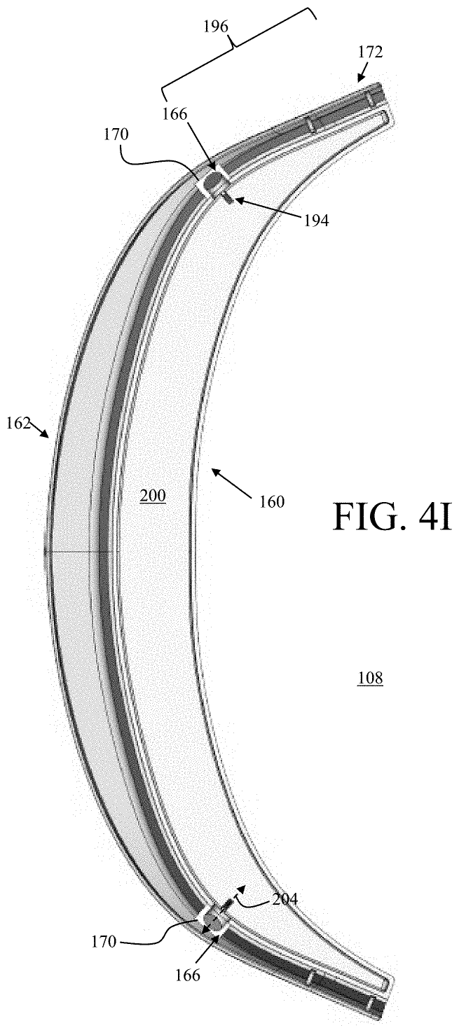

FIGS. 4A to 4I are non-limiting exemplary illustrations of a headrest of PPE shown in FIGS. 1A to 3F in accordance with one or more embodiments of the present invention. As illustrated in FIGS. 1A to 4I, headrest 108 is comprised of a generally arced configuration adapted to snug fit onto a curvature of a forehead.

Headrest 108 includes a headrest body 160 and a brim 162. Brim 162 functions as a visor, allowing blocking of unwanted light. In addition, brim 162 provides for protection for shield 106 and mask 102 against falling airborne particulates and debris. A front side 164 of headrest body 162 includes lateral reliefs 166 formed from cut-outs 170 that function as slots for inserting of top periphery edge 122 of shield 106. Front side 164 of headrest body 162 may optionally further includes lateral head-strap openings (shown by dashed line circles) near distal ends 172 for mounting a head strap. First and second laterally head-strap openings 174 are positioned in between respective first and second lateral reinforcement pair 180 and 182 for mounting a strap.

A backside 184 of headrest body 160 includes a smooth surface 186 upon which a padding such as a soft foam member may be secured. The arced headrest 108 further includes a bottom side (best shown in FIGS. 4H to 4I) that has a front recess 188 formed between front side 164 of headrest body 160 and a channel wall 190. Front recess 188 extends along a span-length of the arc of headrest 108 and includes sufficient depth 192 to receive top periphery edge 122 of shield 106.

Arced headrest 108 further includes a bottom side that has interlocking projections 194 that are located at lateral distal sections 196, near distal ends 172 of headrest 108, aligned with lateral reliefs 166. Interlocking projections 194 extend from channel wall 190, and include an engagement end 198 that protrude from a free distal end of interlocking projections towards lateral reliefs 166. Interlocking projections 194 flex (direction shown by arrows 204 in FIG. 4J) to enable engagement ends 198 to engage (or snap into) and interlock with corresponding lateral openings 134 of shield 106.

The bottom side of headrest body 160 further includes a first lateral reinforcement pair 180 and a second lateral reinforcement pair 182 near distal ends 172 of headrest body 160 for facilitating a tighter hold-radius of shield 106.

As further illustrated, the bottom side of headrest body 160 also includes a rear recessed section 200 formed between channel wall 190 and a rear wall (or backside) 184 of headrest body 160. Rear recessed section 200 tapers to narrow lateral sections 202, forming the general bottom side of headrest body 160.

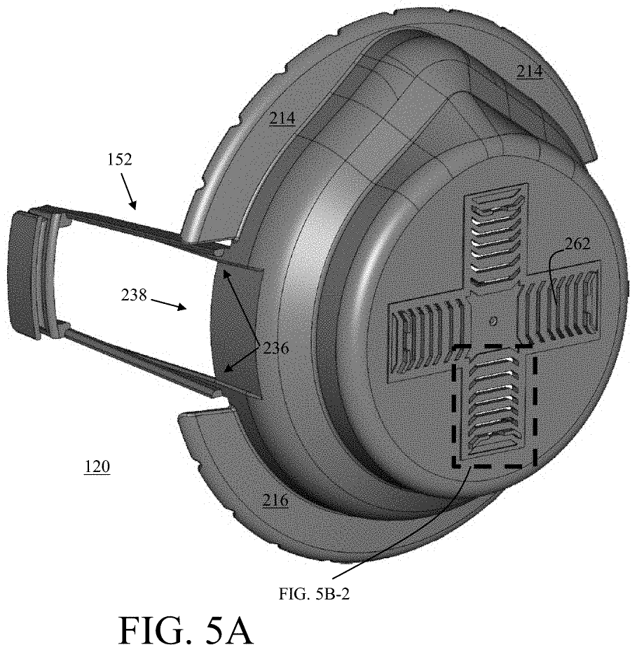

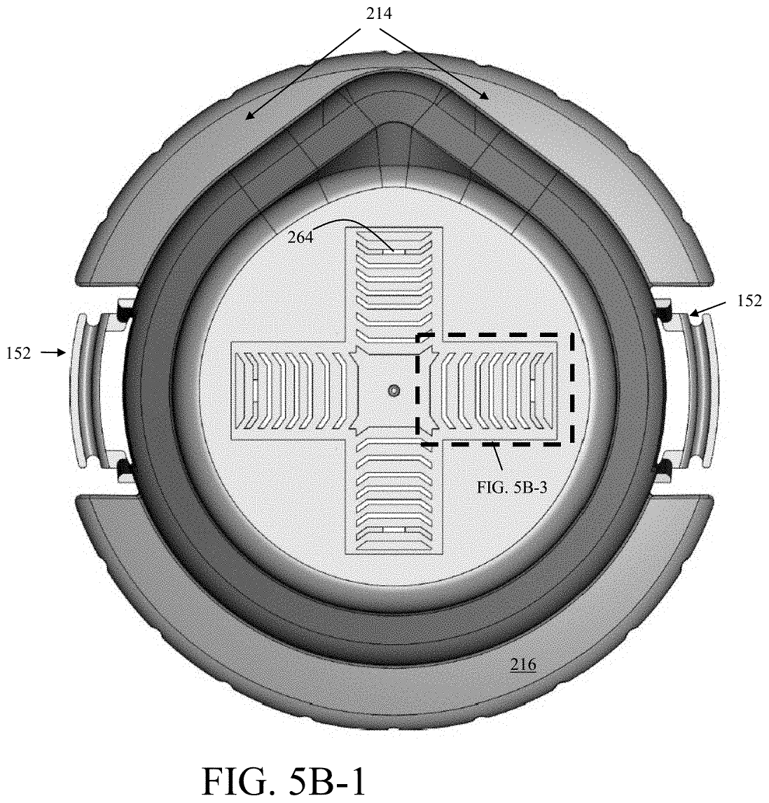

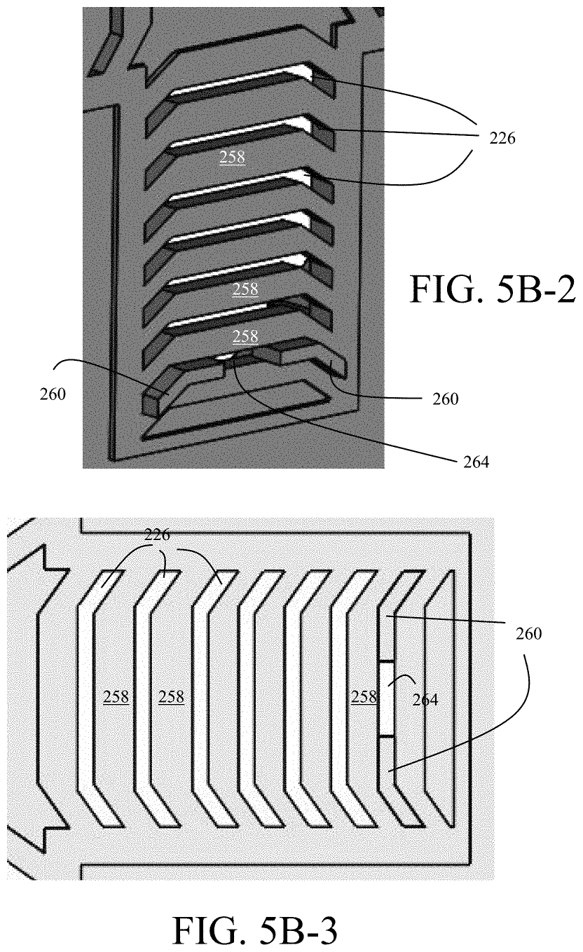

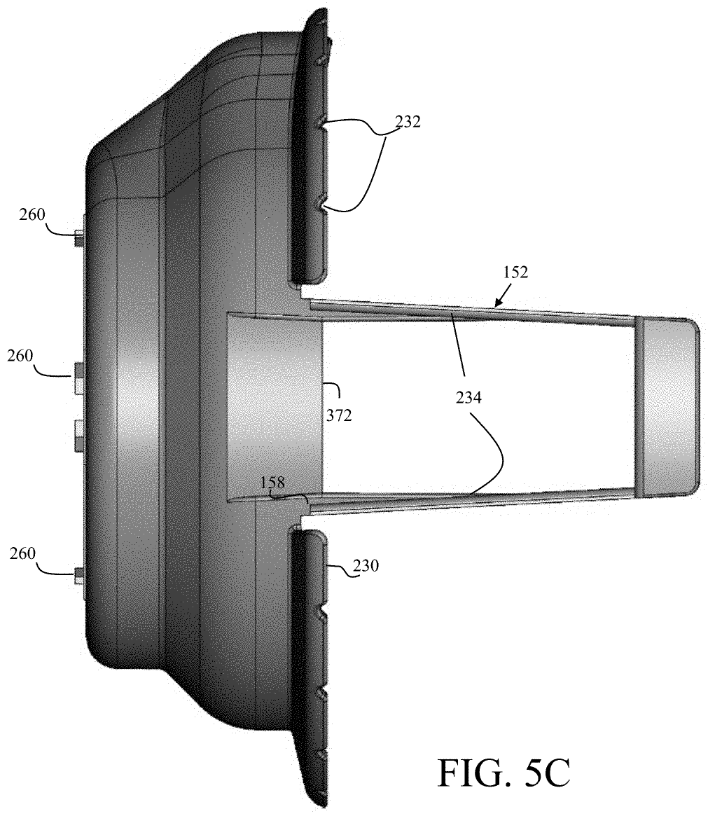

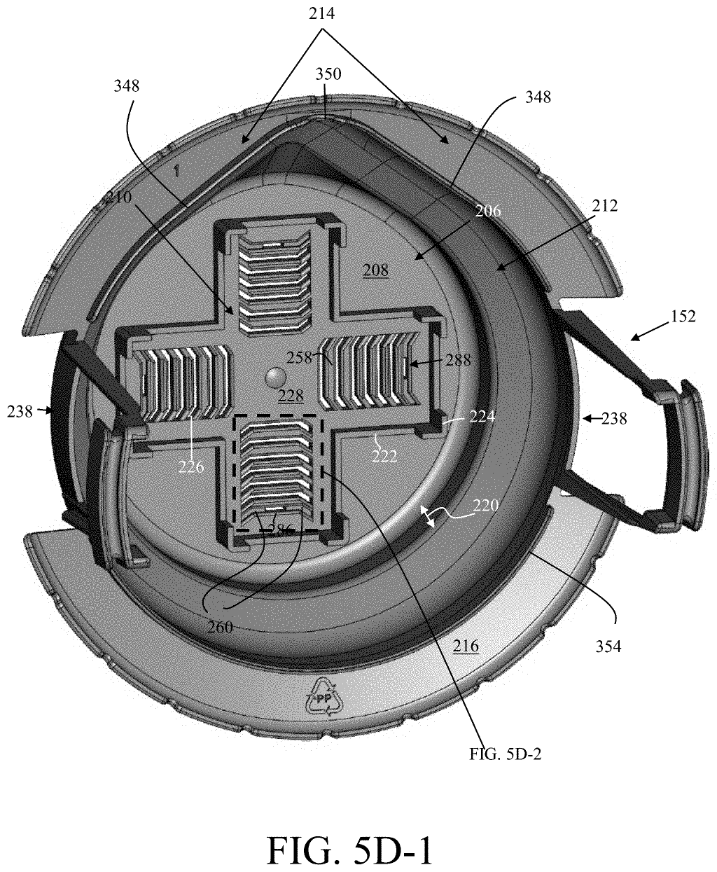

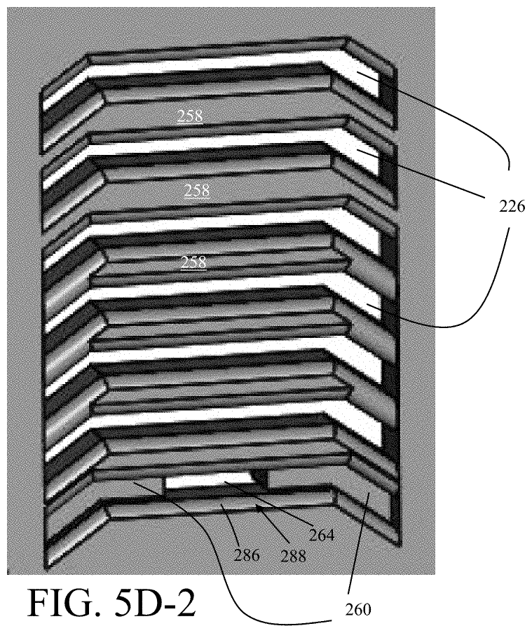

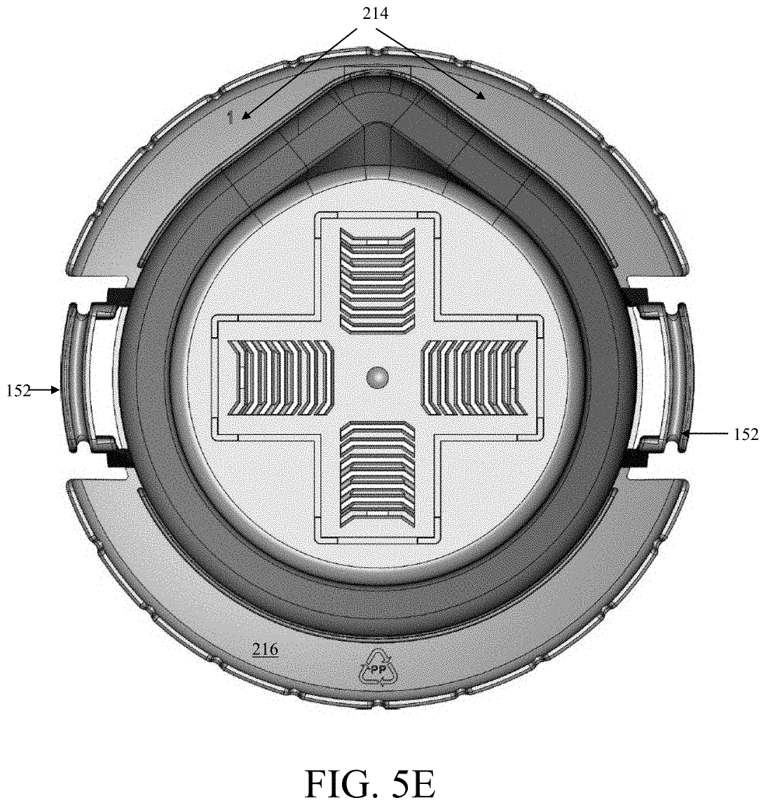

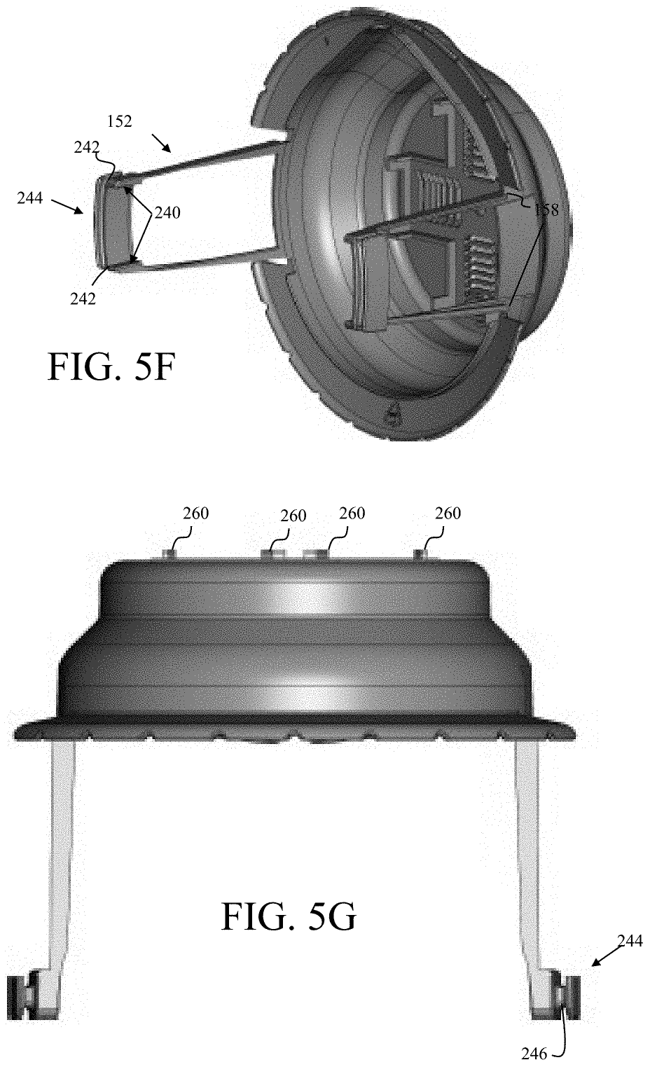

FIGS. 5A to 5G are non-limiting exemplary illustrations of a respirator of PPE shown in FIGS. 1A to 4I in accordance with one or more embodiments of the present invention. As illustrated in FIGS. 1A to 5G, interior side (FIGS. 5D to 5F) of respirator 120 includes a filter chamber 206 having a bottom surface 208 that includes a filter housing 210.

Filter chamber 206 has sufficient depth 220 measured from bottom surface 208 of filter chamber 206 to accommodate filter housing 210, filter 116, and a filter housing cover 118, while allowing sufficient clearance for mouth and nose. Further included is a main chamber 212 adapted to ergonomically accommodate and cover over the mouth and the nose.

Respirator 120 also included are upper and lower flanges 214 and 216 that enable respirator 120 to be securely seated against an exterior surface 218 of shield 106. Respirator 120 further includes a pair of identical lateral temples 152.

Filter housing 210 is comprised of walls 222 for housing filter 116, and elongated alignment guides 224 that form the corners of walls 222 that facilitate in mating filter housing cover 118 with filter housing 210. As further detailed in FIGS. 5A to 5G and in particular, FIGS. 5B-1, 5B-2, and 5D-2, filter housing 210 is further comprised of a set of openings 226 at a base 228 of filter housing 210 that function as vents. The vent openings 226 are defined by vent grids 258. As further detailed below, filter 118 is positioned within filter housing 210 and covered over and secured in place by filter housing cover 118.

As further shown, filter housing 210 of respirator 120 also includes standoffs 260 positioned at distal end vent openings 226, extending out of exterior side 262 of base 228 of filter housing 210. Standoffs 260 facilitate the resting of respirator 120 on a surface while preventing interlocking projections 254 of filter housing cover 118 from disengaging from filter housing 210. As also further detailed below, interlock openings 264 in between the pair of standoffs 260 (best shown in FIGS. FIGS. 5B-1, 5B-2, and 5D-2) function to receive interlocking projections 254. In general, the overall height of standoffs 260 is of sufficient length to prevent unintentional disengagement of interlocking projections 254 from interlocking opening 264.

It should be noted that the number, type, size, and configuration/arrangement of vents may be varied and need not be a cross configuration. For example, vents may be arranged in oval configuration rather than cross configuration, etc.

As further illustrated in FIGS. 5A to 5G, upper and lower flanges 214 and 216 of respirator 120 include periphery edges 230 that are curved inward (towards the face of the user), facilitating the seating of respirator 120 against exterior surface 218 of shield 106, and providing spacing between flanges 214 and 216 and exterior surface 218 of shield 106.

Respirator 120 also includes a lower interlocking projection 354 and an upper interlocking projection 348, with upper interlocking projection 348 having a dip (or cut-out) 350 that functions as an ergonomic relief “or nose bridge” for the nose. This way, upper interlocking projection 348 does not press against the nose during use.

Periphery edges 230 further include equally distanced notches 232 along an arced length of the periphery edges 230, with the spacing and notches 232 facilitate airflow 338, prevent accumulation of debris, and facilitate easy cleaning.

Lateral temples 152 of respirator 120 are comprised of identical first lateral temple and second lateral temple, having a pair of projections 234 having base ends 236 extending from lateral sides 238 of respirator 120, with base end 236 forming living hinges 158.

Living hinges 158 allow the entire temples 152 to flex divergently way from each other, or convergently towards each other. This facilitates assembly of the mask 102 onto shield 106 and further, facilitates in wearing the fully assembled EEP. As the user wears the EEP, the temples 152 mechanically flex to fit to a users face.

As further illustrated, pair of projections 234 have a top end 240 that converge and are connected to lateral sides 242 of an earpiece connector 244. Earpiece connector 244 is comprised of a recess or groove 246 that receives an adjusting portion 248 of earpiece 114.

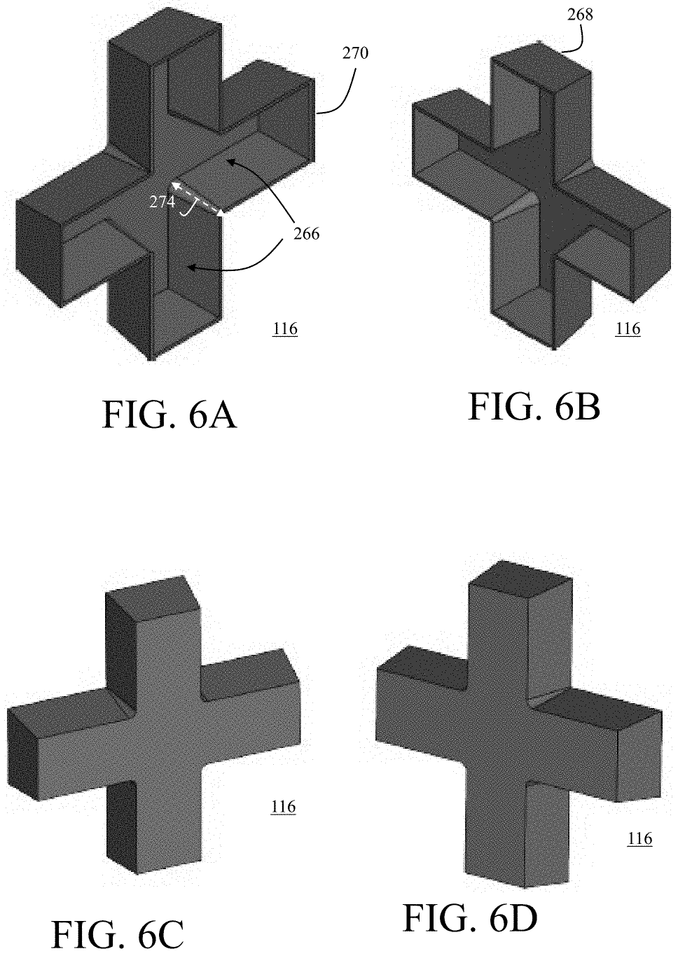

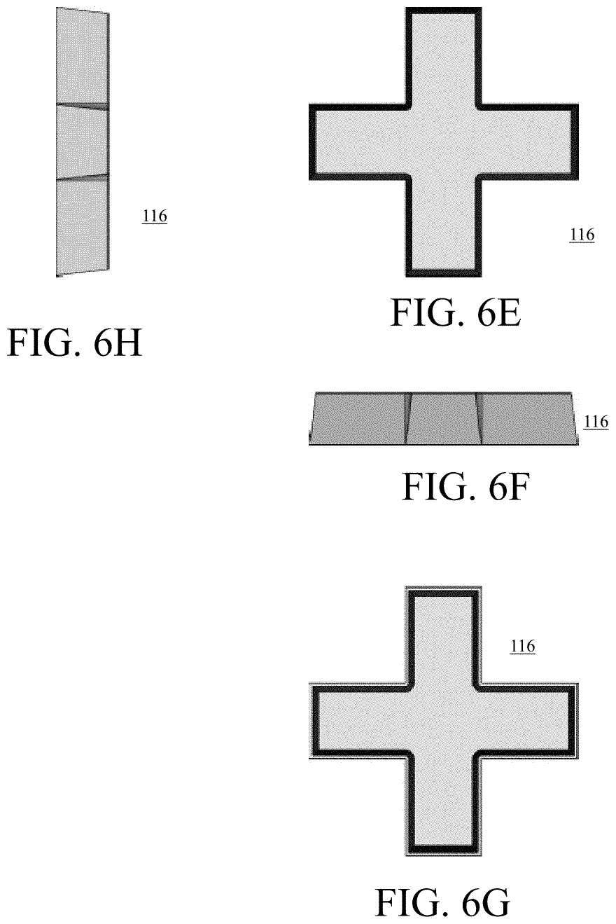

FIGS. 6A to 6H are non-limiting exemplary illustrations of a filter of PPE shown in FIGS. 1A to 5G in accordance with one or more embodiments of the present invention (FIG. 6E is a bottom view and 6G is top view.) As illustrated in FIGS. 1A to 6H, filter 116 is configured commensurate with the shape of filter housing 210 and filter housing cover 118.

Filter 116 has an overall cross shaped outline, configured commensurate with the cross shaped outline of filter housing 210 and the cross shaped outline of filter housing cover 118. The cross-sectional profile of filter 116 is comprised of as an isosceles trapezoidal trough (or cavity 266), with shorter base 268 of the isosceles trapezoid forming the closed side of the filter 116, with the longer base 270 forming the opening of cavity 266. As further detailed below, a depth length 274 of cavity 266 is longer than the length of the inner wall height 276 of inner perimeter wall 252 of filter housing cover 118. Filter 116 may comprise of a High Efficiency Particulate Air (HEPA) filter.

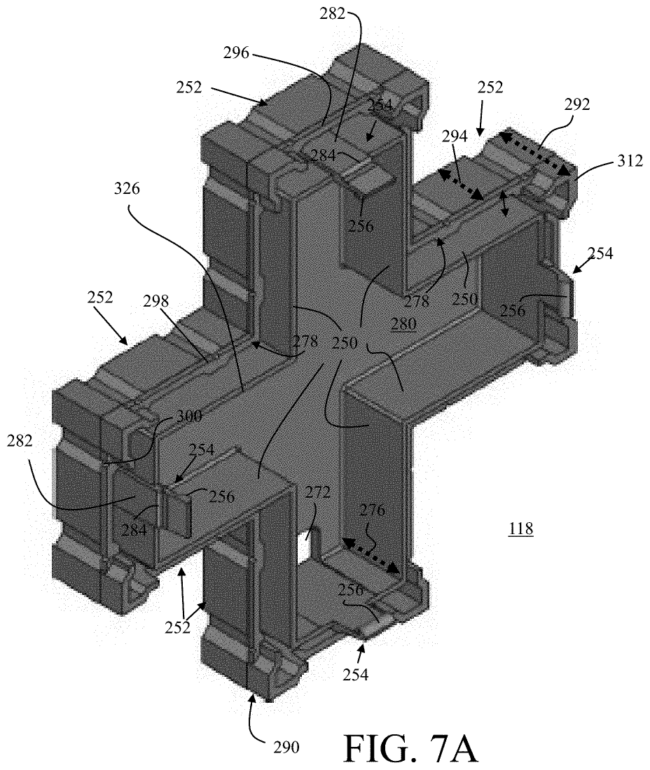

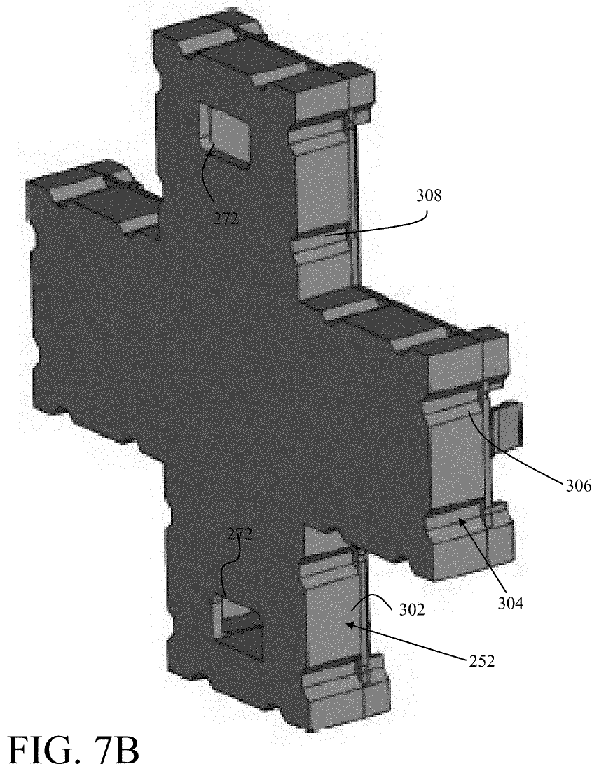

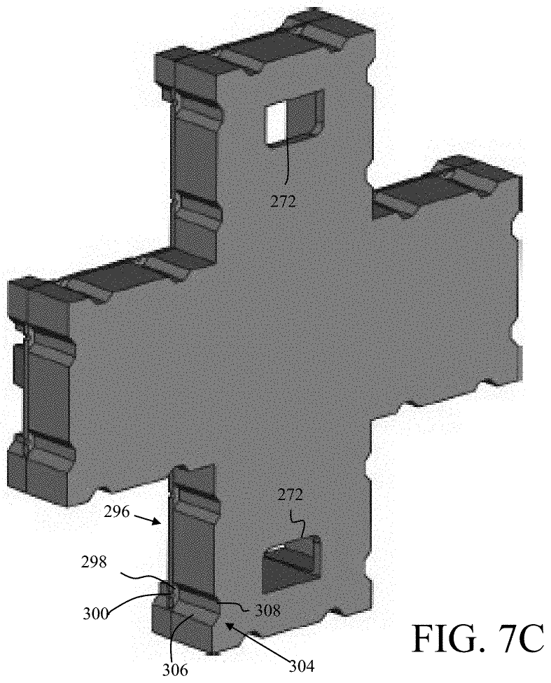

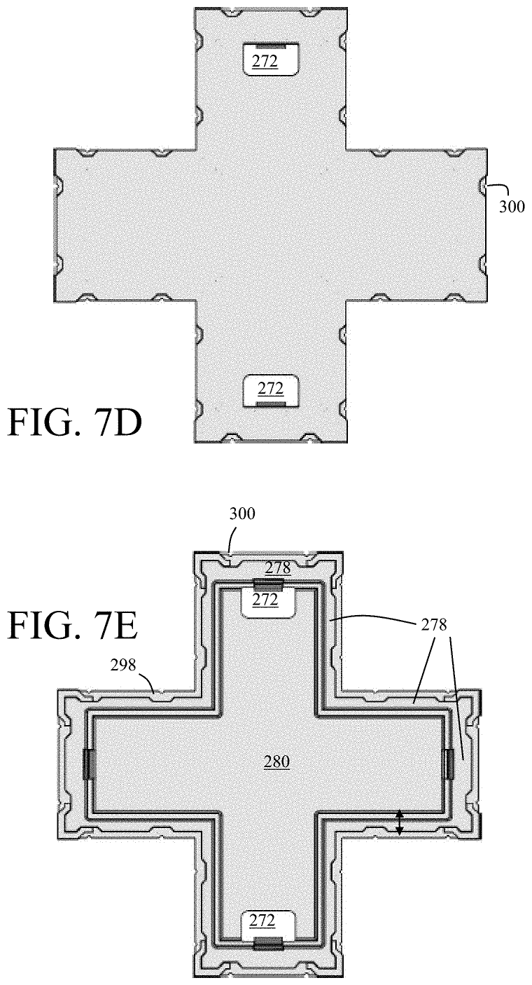

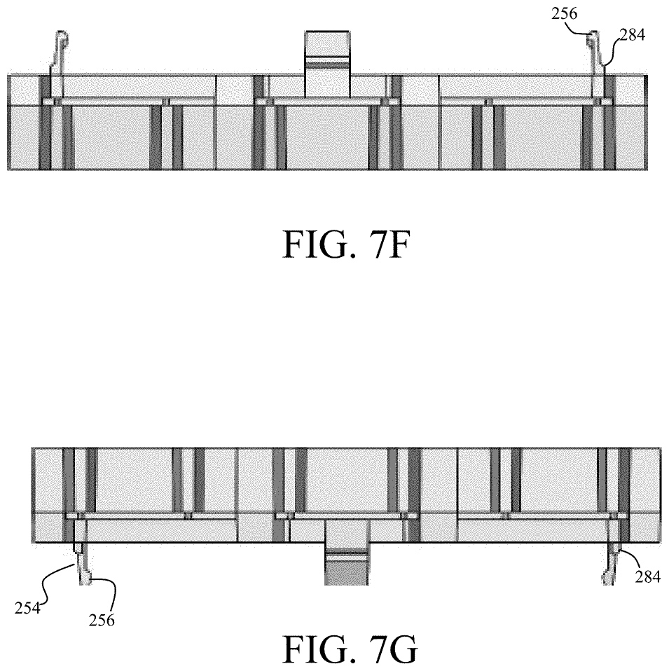

FIGS. 7A to 7G are non-limiting exemplary illustrations of a filter housing cover of PPE shown in FIGS. 1A to 6H in accordance with one or more embodiments of the present invention.

As illustrated in FIGS. 1A to 7G, filter housing cover 118 includes inner perimeter walls 250 for securing filter 116. Further included are outer perimeter walls 252 that run parallel inner perimeter walls 250 for securing filter housing cover 118 to filter housing 210 (further detailed below). A distance 278 between inner perimeter walls 250 and outer perimeter walls 2520 functions as filtered ventilation channel (detailed further below).

As further illustrated, at least one inner perimeter wall 250 includes an interlocking projection 254 with an engagement protuberance 256 at distal end that interlocks (or interference fits) with interlock openings 264.

Inner perimeter wall 250 defines a chamber 280 that houses filter 116. Chamber 280 includes a first and a second filtered air intake openings 272 for inhaling of clean, filtered air. That is, as a user inhales, unfiltered air moves through vents 226, entering cavity 266 of filter 116, passing through filter 116, with filtered clean air inhaled via intake openings 272 of filter housing cover 118.

It should be noted that the number and position of intake openings 272 within chamber 280 may be varied and is not limited to the two at the illustrated positions within chamber 280, so long as intake openings 272 are fully covered over by filter 116.

One or more inner perimeter wall 250 includes an interlocking projection 254 with an engagement protuberance 256 at distal end that detachably interlocks with interlocking opening 264 of filter housing 210. As indicated above, engagement protuberance 256 interference fits within interlocking opening 264 of filter housing 210 to block and prevent any airflow 338.

One or more inner perimeter wall 250 that includes interlocking projection 256 further includes a reinforcement addition 282 with an upper curved side 284 that contacts a curved inner side 286 of distal grid 288 of interlock openings 264 to block and prevent airflows 338 (best shown in FIGS. 8I-2 and 8I-3). Reinforcement addition also functions as a stop to prevent over extending (pushing) filter housing cover 118 against filter housing 210 once interlocking projection 256 engage with interlock openings 264.

As further illustrated, outer perimeter walls 252 form elongated outer corners 290 having a corner height 292 with a longer length than an outer wall height 294 of outer perimeter walls 252. Additionally, corner height 292 of elongated outer corner 290 of outer perimeter walls 252 is also longer than an inner wall height 276 of inner perimeter walls 250. Further, inner wall height 276 of inner wall perimeter 250 is longer than outer wall height 294.

A periphery edge 296 of outer perimeter wall 252 of filter housing cover 118 includes an outer flange 298 with indentations 300 for redirecting filtered airflows 446. An outer surface 302 of outer perimeter wall 252 of filter housing cover 118 includes recesses 304 with beveled side walls 306 and a flat base 308 that function as airflow guides to further redirect filtered airflows 446 from indentations 300 towards the user respiratory organs (mouth/nose).

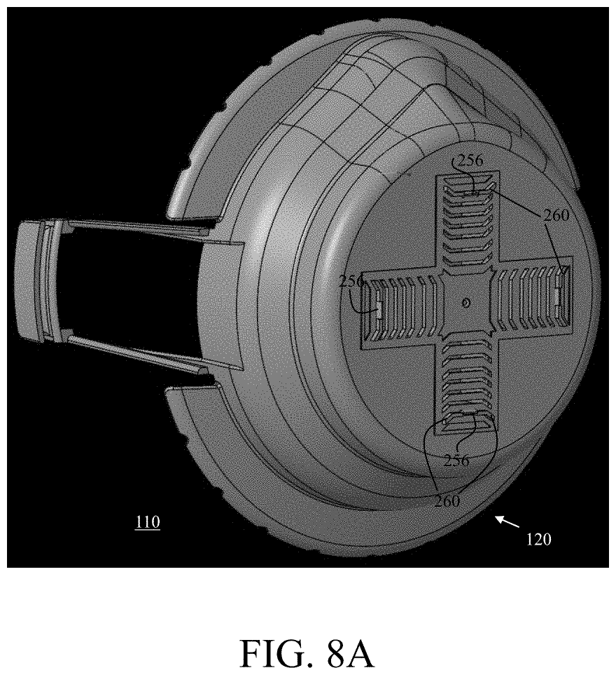

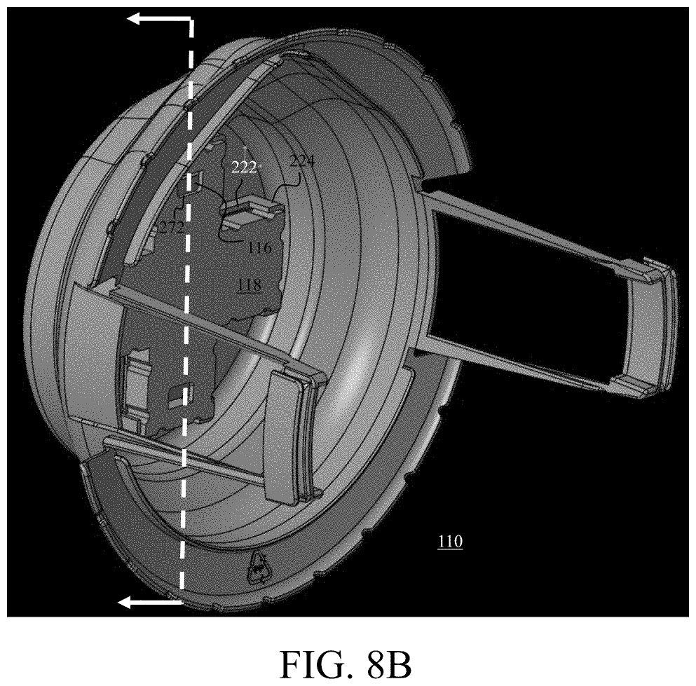

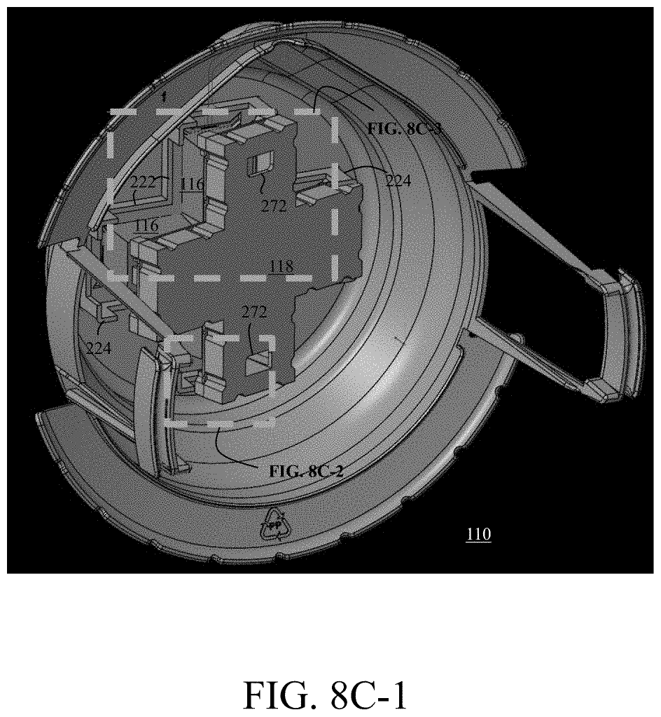

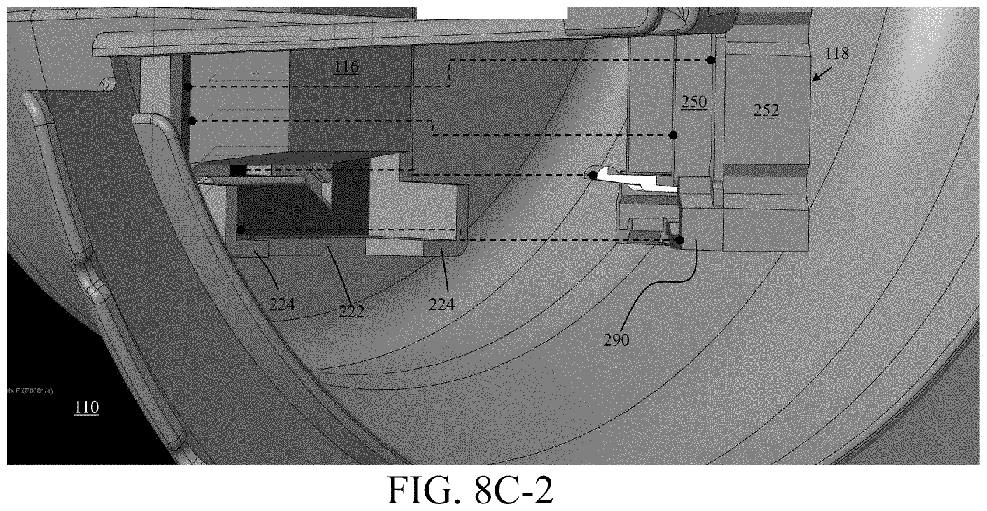

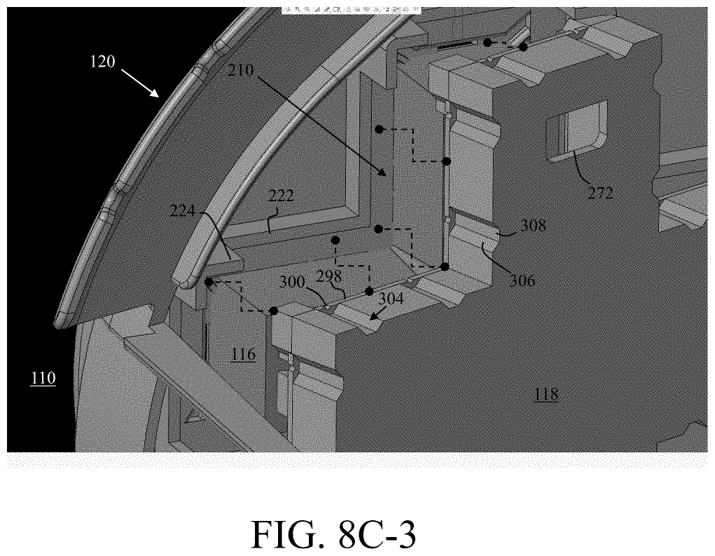

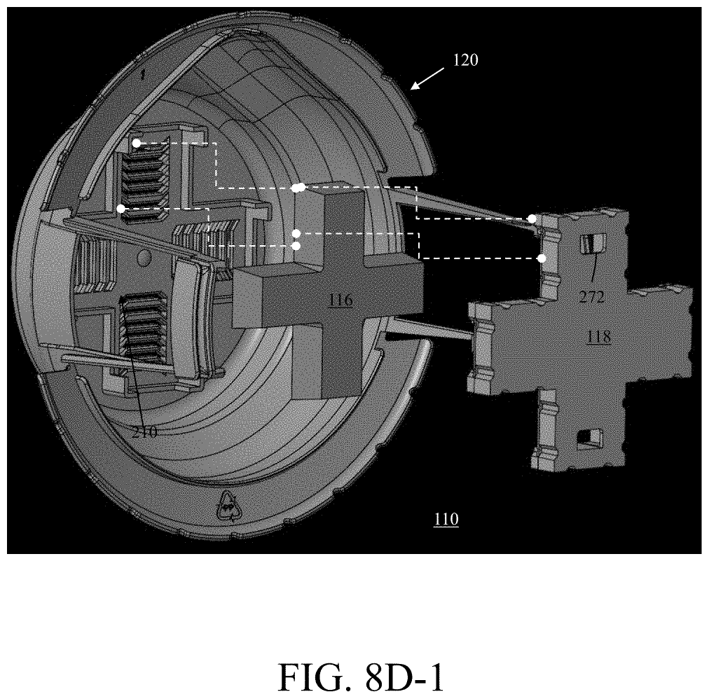

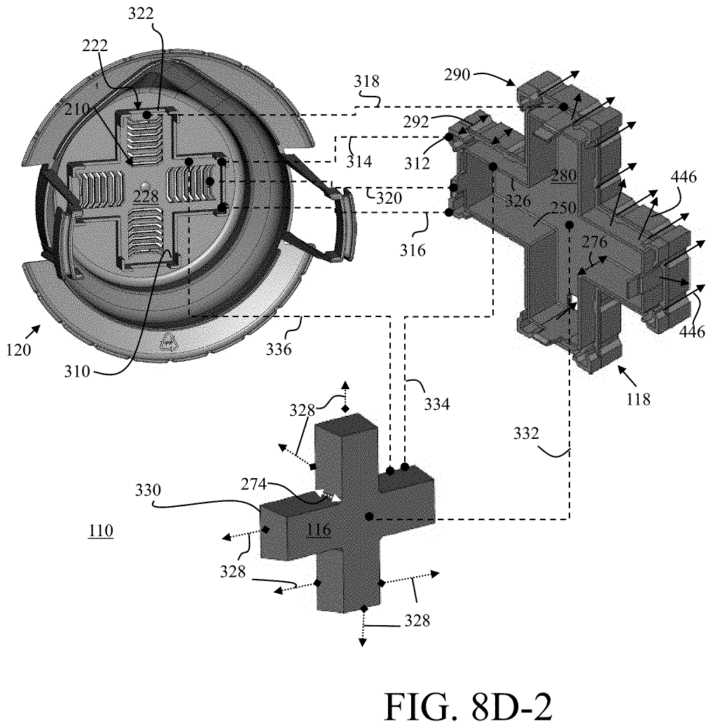

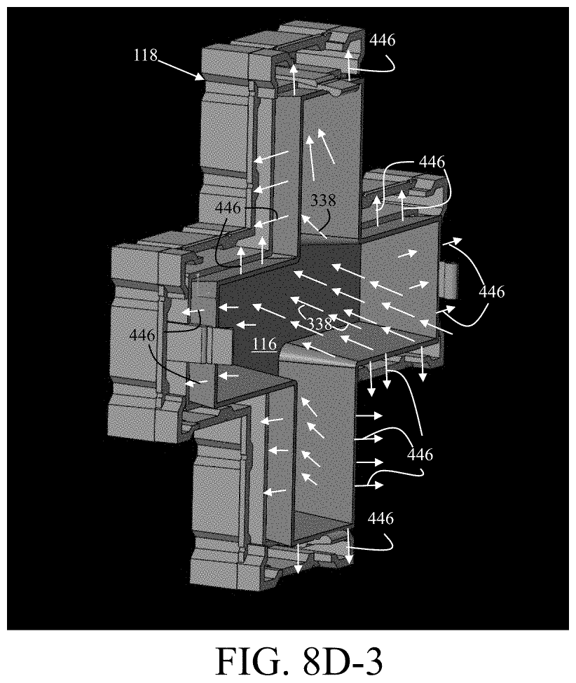

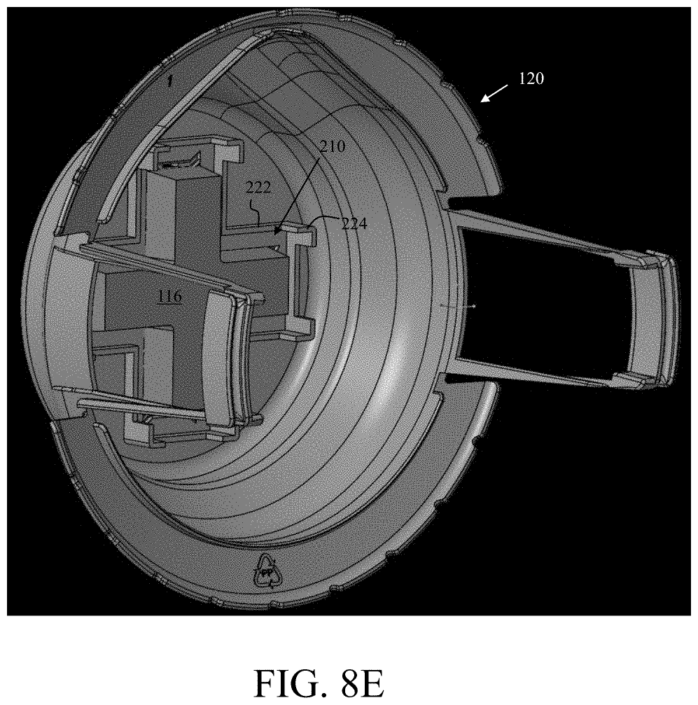

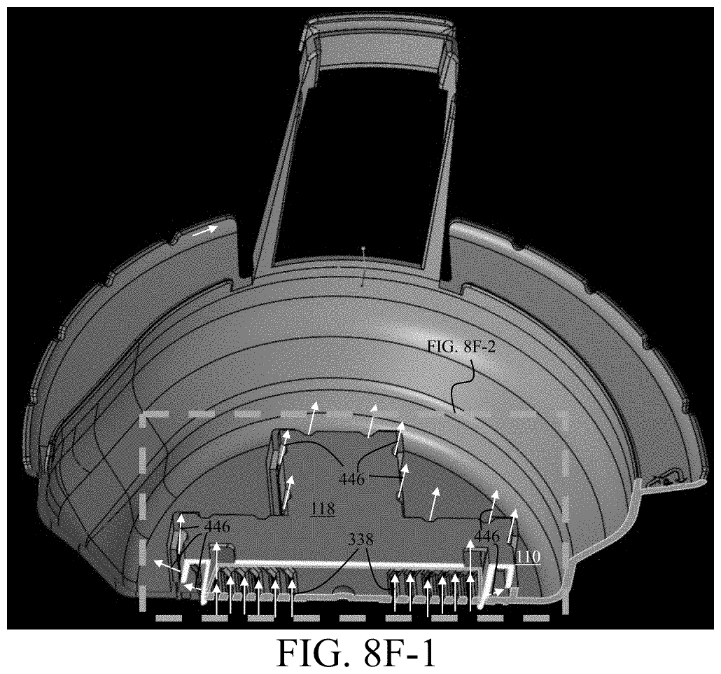

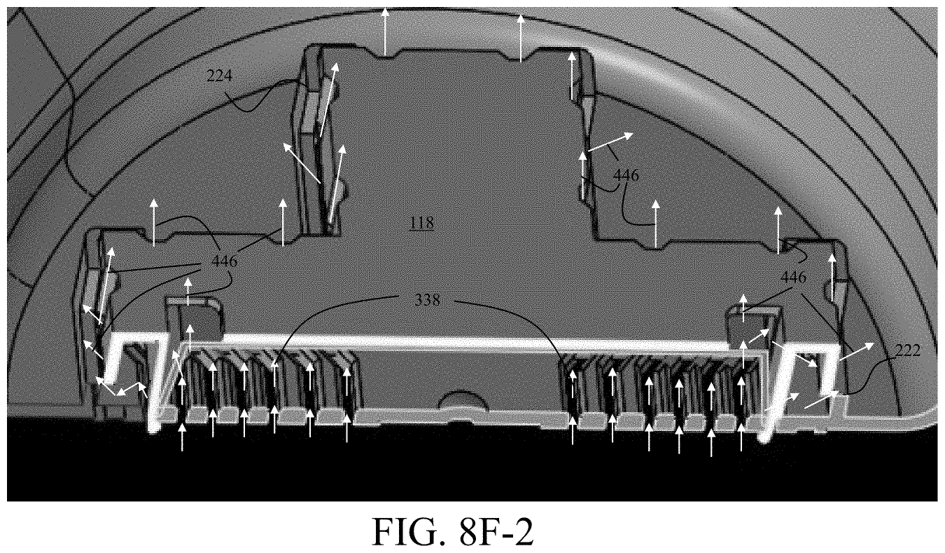

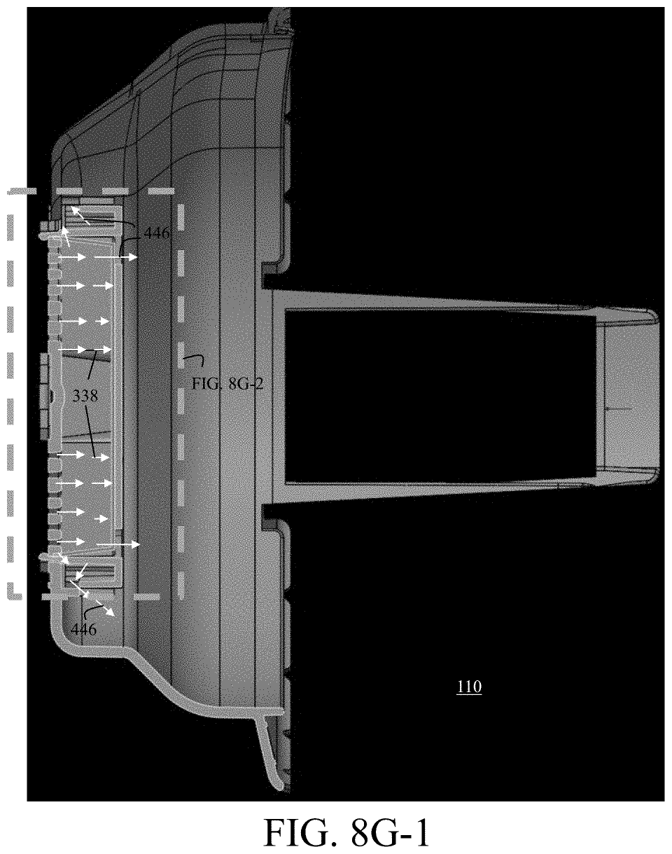

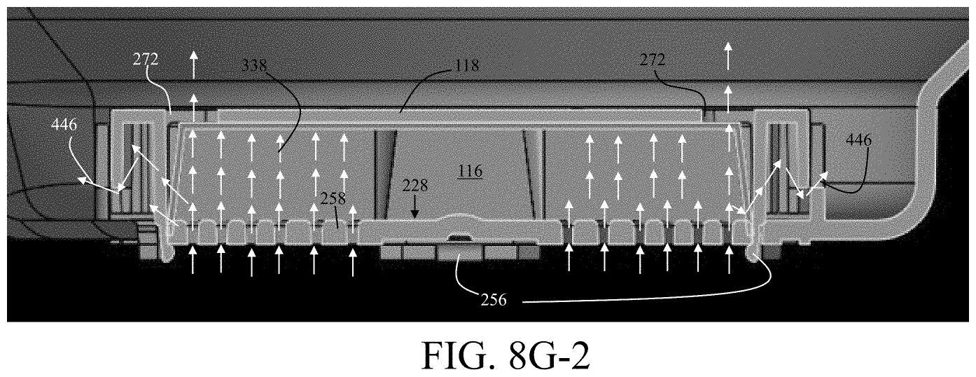

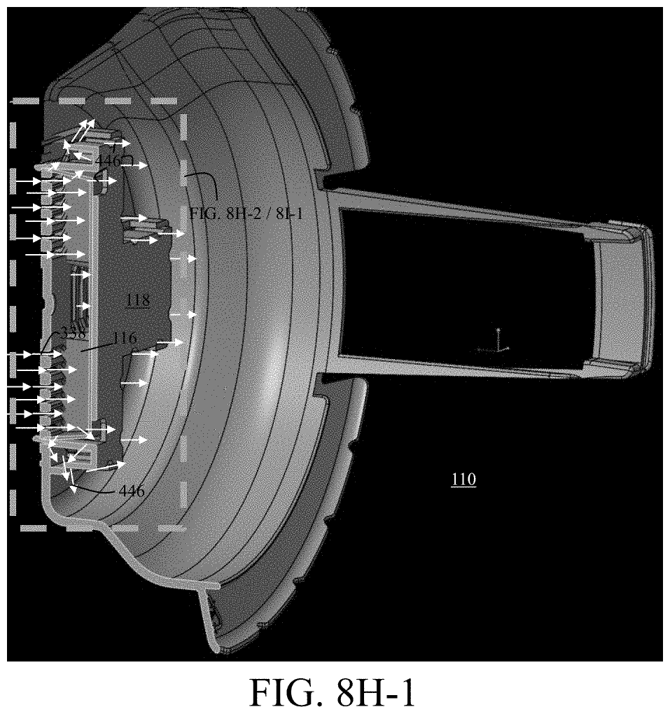

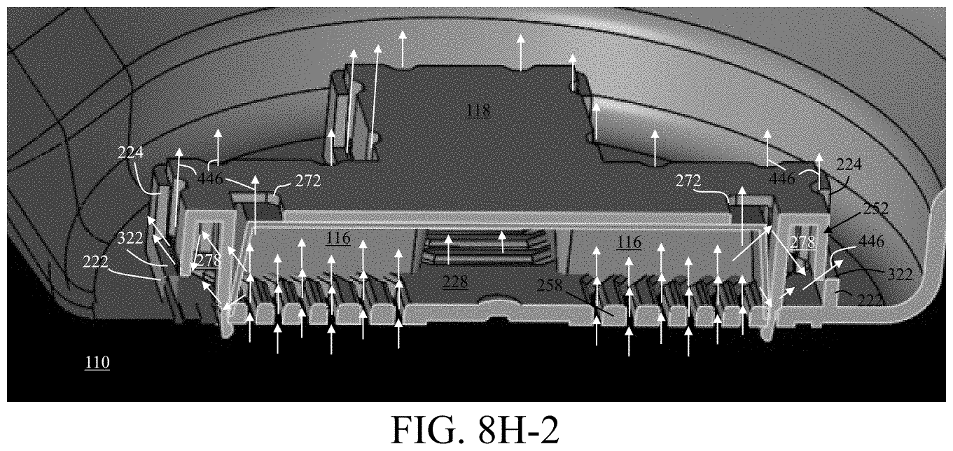

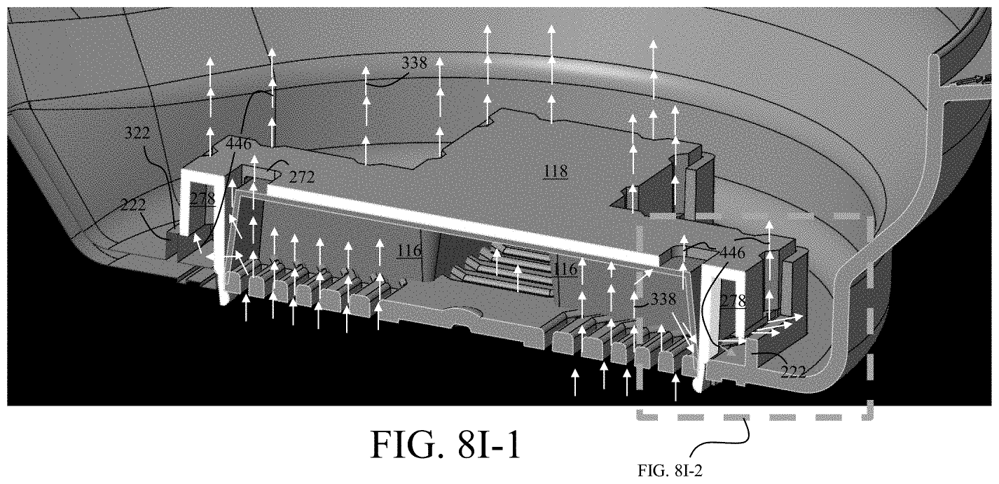

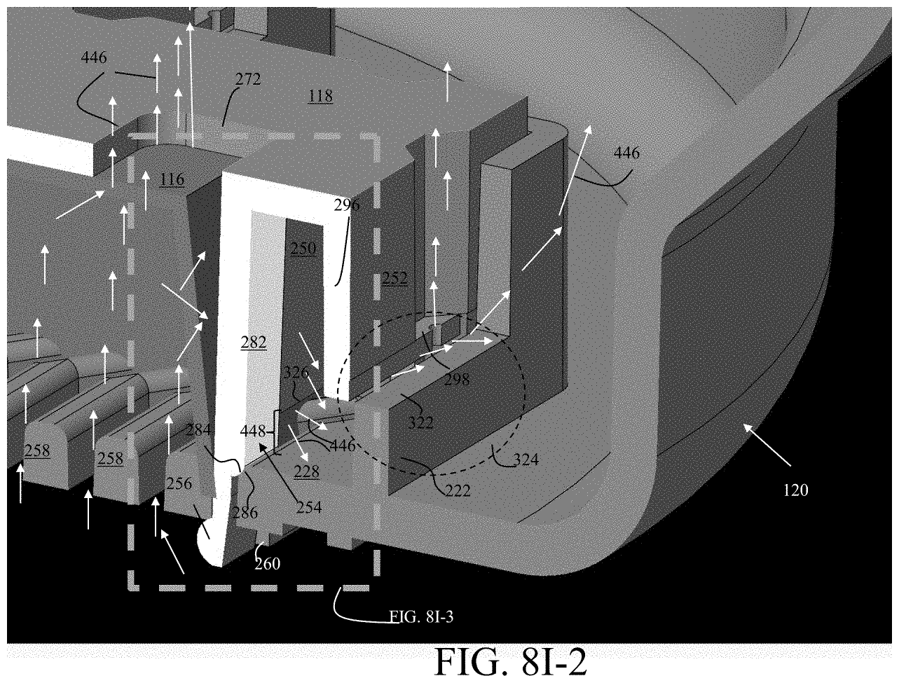

Further features and aspects of filter housing cover 118, filter 116, filter housing 210, including airflows 338 and filtered airflows 446 are detailed below in relation to FIGS. 8A to 8I-3.

FIGS. 8A to 8I-3 are non-limiting exemplary illustrations of cooperative working relationship between respirator, filter housing, filter, and filter housing cover of respirator assembly of PPE shown in FIGS. 1A to 7G, including a non-limiting, exemplary method of detachable connectivity thereof in accordance with one or more embodiments of the present invention.

As shown in FIGS. 1A to 8I-3, filter 116 fits within filter housing 210, with cavity 226 of filter 116 facing and covering over all vent openings 226. Filter housing cover 118 also fits within filter housing 210, securing filter 116 in between filter housing 210 and filter housing cover 118.

In particular, as best shown in FIG. 8D-2 and 8D-3 when assembled, as shown by phantom lines 314 and 316 the elongated outer corners 290 of outer perimeter walls 252 form lead-ins that slip-fit adjacent inner sides 310 of elongated corner alignment guides 224, which are wall junctions of filter housing 210, with top surface 312 of elongated outer corners 290 of outer perimeter walls 252 resting on base 228 of filter housing 210. Interlocking projections 254 are illustrated to connect with interlocking openings 264 by phantom lines 320.

Corner heights 292 of the elongated outer corners 290 of outer perimeter walls 252 are of sufficient length to prevent a periphery edge 296 of outer perimeter wall 252 of filter housing cover 118 from contacting periphery edge 322 of filter housing walls 222 (as shown by phantom line 318).

More specifically, as best illustrated in FIGS. 8D-2, and 8I-1 to 8-3, a periphery edge 296 of outer perimeter wall 252 (including, flange 298) is within filter housing 210, inside a perimeter defined by periphery edge 322 of filter housing walls 222 and raised above periphery edge 322 of filter housing walls 222 of filter housing 210. This arrangement provides a first lateral peripheral gap 324 (marked by circular phantom circular line in), enabling cover 118 and housing 210 combination to also function as a diverter or deflector periphery vent, providing additional lateral filtered airflows 446 (as also best shown in FIG. 8D-3).

Referring back to FIG. 8D-2 and 8D-3, and FIG. 8I-2, as indicated above, corner heights 292 of the elongated outer corners 290 of outer perimeter walls 252 are longer than inner wall height 276. This prevents a periphery edge 326 of inner perimeter wall 250 from contacting base 228 of filter housing 210. This arrangement provides a second lateral peripheral gap 448 for lateral peripheral venting of filtered air 446.

Additionally, since height 274 of filter 116 is longer than inner perimeter wall height 276 (best shown in FIG. 8D-3), when assembled, chamber 280 of filter housing cover 118 preloads (compresses) filter 118 (best shown by phantom line 332), “spreading” filter structure generally equally in all directions shown by arrows 328 over all vent openings 226.

Concurrently, periphery edge 326 of inner perimeter wall 250 also preloads periphery edges 330 of filter 118 as shown by phantom line 334, which enables further “spreading” of periphery edge 330 over base 228 as shown by phantom line 336.

Referring to FIGS. 8I-2 and 8I-3, as indicated above, interlocking projection 254 include a reinforcement addition 282 with an upper curved side 284 that contacts a curved inner side 286 of distal grid 288 of interlock openings 264 to block and prevent airflows 338. Reinforcement addition also functions as a stop to prevent over extending (pushing) filter housing cover 118 against filter housing 210 once interlocking projection 254 engage with interlock openings 264.

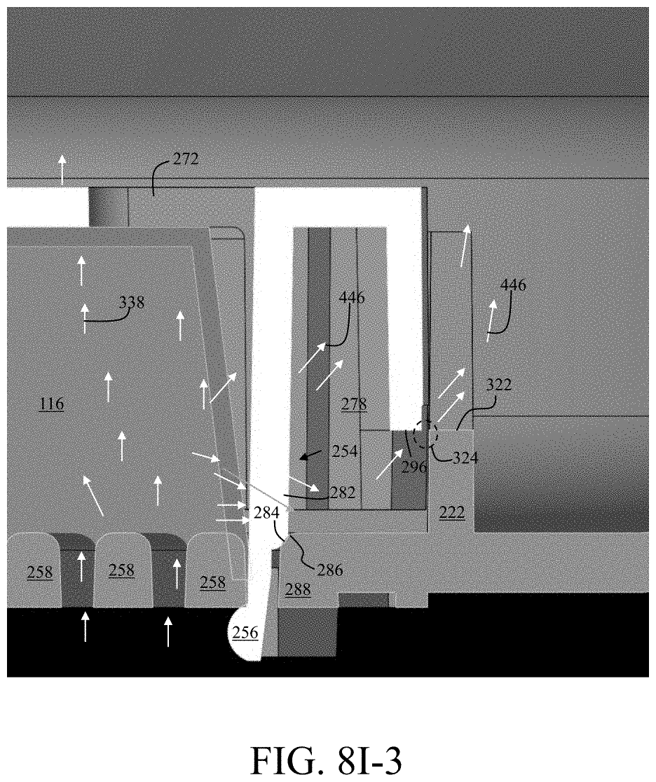

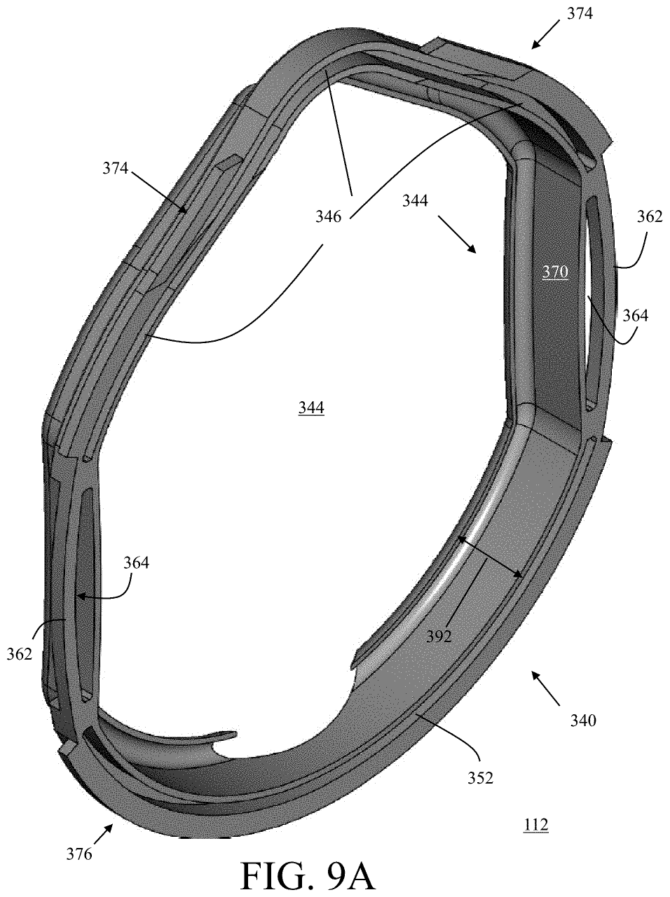

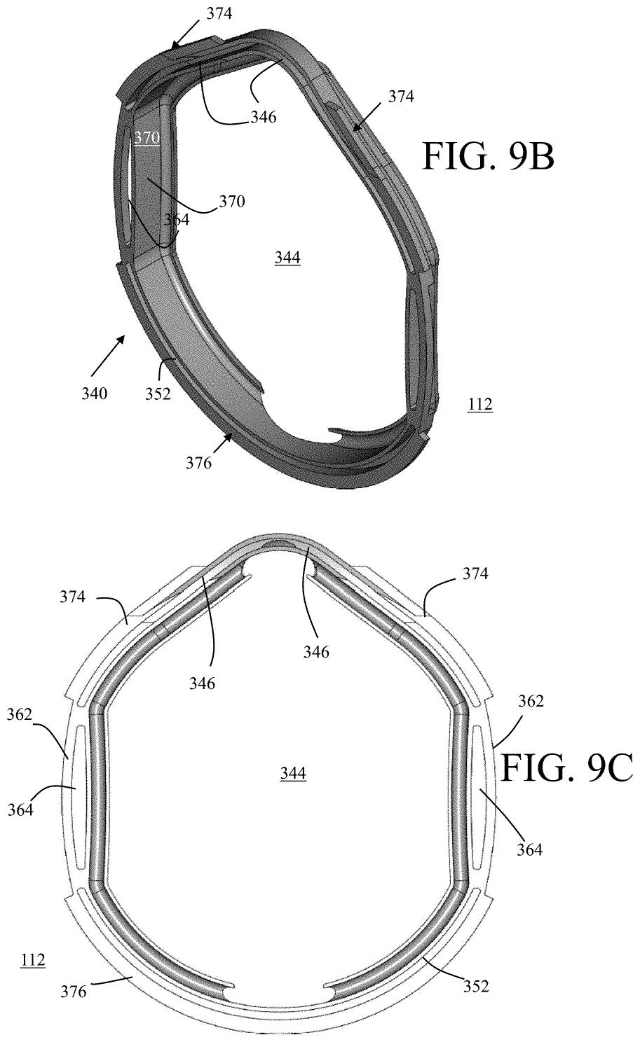

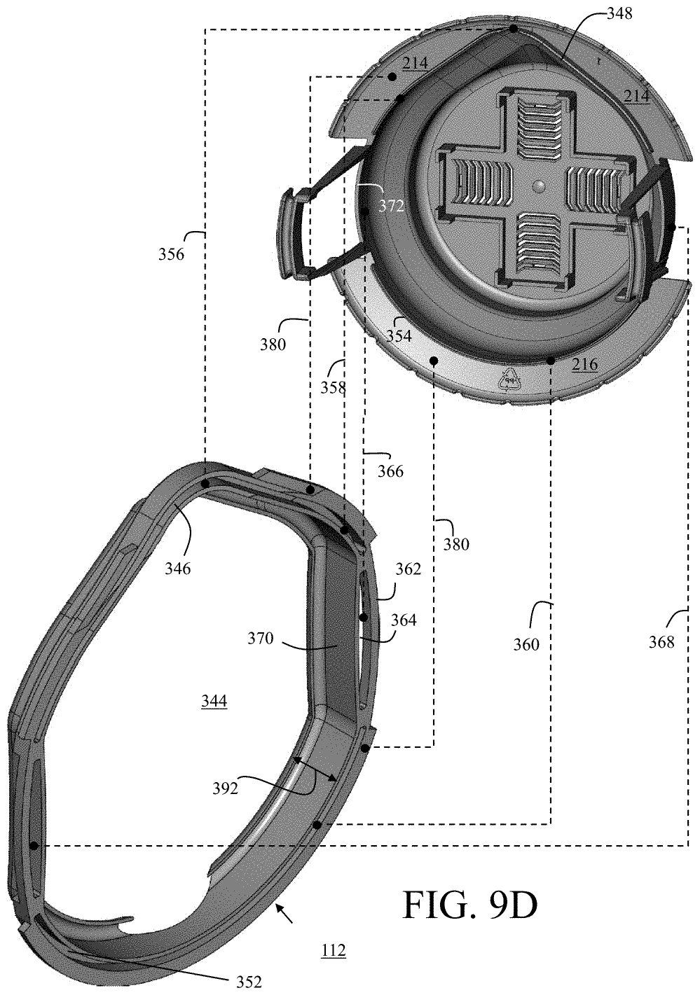

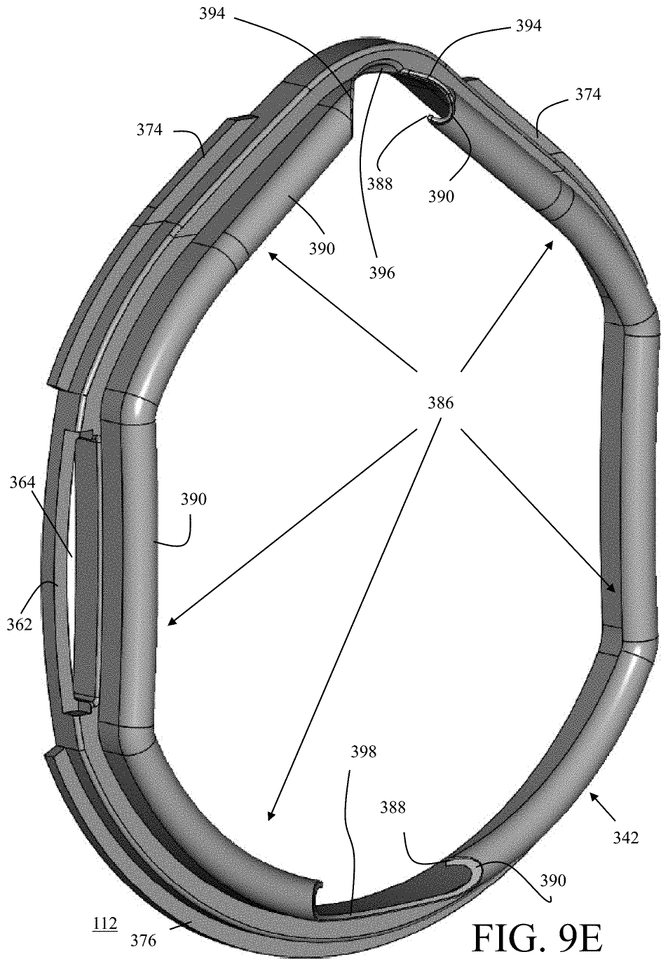

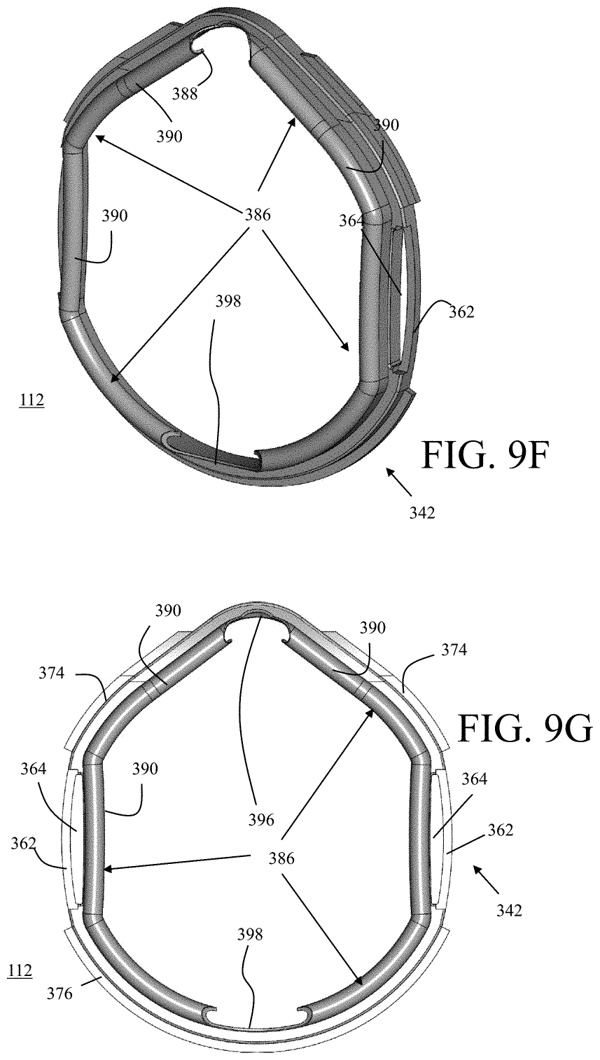

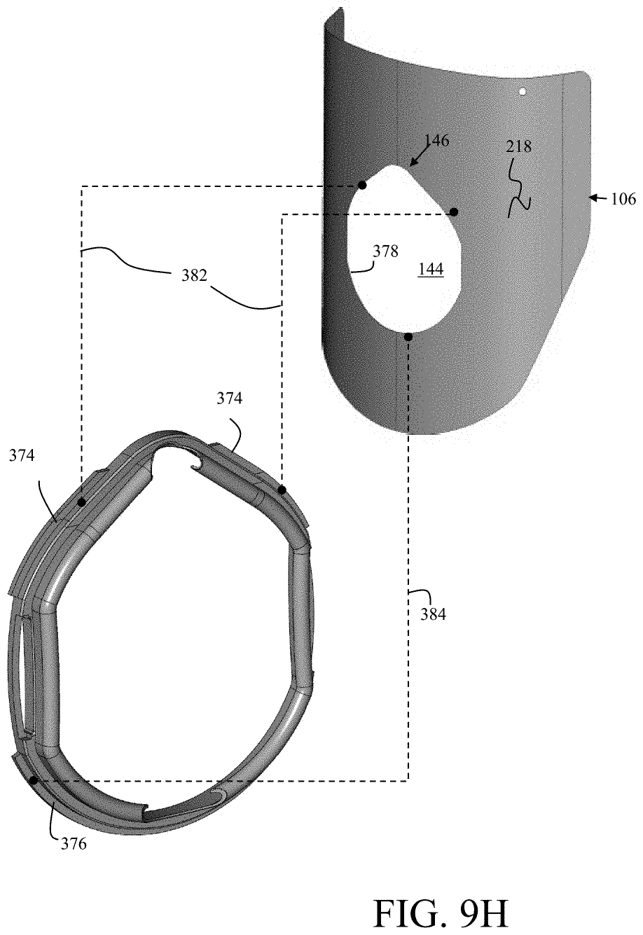

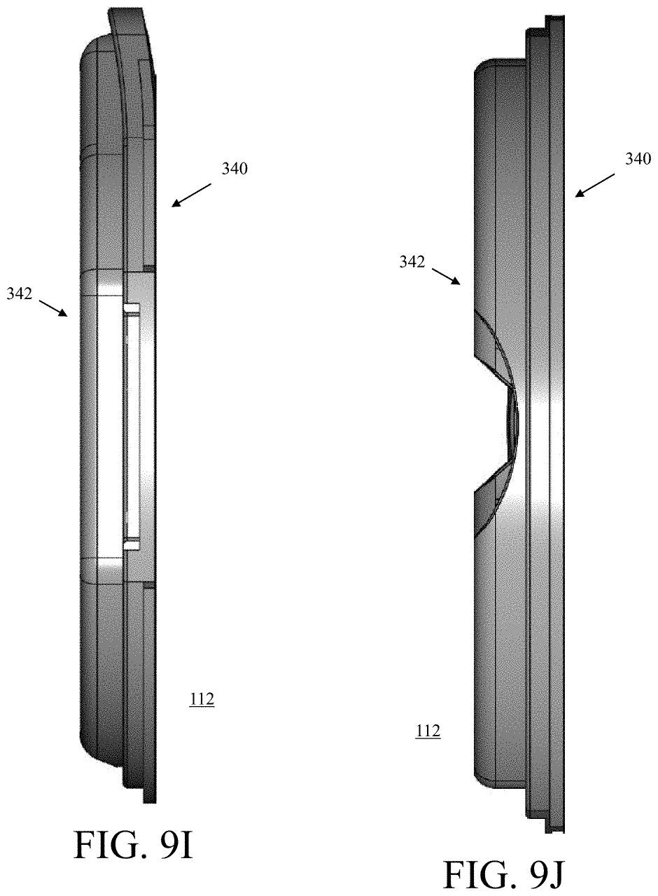

FIGS. 9A to 9J are non-limiting exemplary illustrations of a seal member of PPE shown in FIGS. 1A to 8I-3 in accordance with one or more embodiments of the present invention. As illustrated in FIGS. 1A to 9J, seal member 112 functions as a seal or “gasket” that is positioned in between an exterior surface 218 of shield 108 and respirator 120.

Seal member 112 is comprised an engagement side 340 (FIGS. 9A to 9D) that engages with the respirator assembly 110, a respirator side 342 (FIGS. 9E to 9H) that further seals and enables breathing through the respirator assembly 110, and an open center 344.

Engagement side 340 of seal member 112 is comprised of an upper interlocking recess 346 for frictional engagement fit with an upper interlocking projection 348 of respirator 120 of respirator assembly 110 (shown with phantom lines 356 and 358 in FIG. 9D).

Engagement side 340 of seal member 112 is further comprised of a lower interlocking recess 352 for frictional engagement fit with lower interlocking projection 354 of respirator 120 of respirator assembly 110 (shown with phantom lines 360 in FIG. 9D).

Seal member 112 is further comprised of lateral attachments 362 with openings 364. Lateral attachment openings 364 receive and engage with respective first and second temples 152 of respirator 120 of respirator assembly 110 (shown with phantom lines 366 and 368 in FIG. 9D).

Lateral attachments 364 is extended to interlock base end 236 (at living hinges 158) of temples 152 of respirator 120 of respiratory assembly 110, securing seal member 112 to respirator 120. This arrangement pulls lateral sides 370 of seal member 112 to be positioned below lateral periphery edge 372 of respiratory 120 (within main chamber 212), thus providing proper seal.

Seal member 112 is comprised of upper lateral flanges 374 and a lower flange 376. These flanges function as “gasket” for sealing shield 106 and respirator 120 as detailed below. Engagement side 340 of flanges 374 and 376 are flat and rest on and are pressed against flange 214 and 216 of respirator 120 as shown by both phantom lines 380 in FIG. 9D.

Respirator side 342 of flanges 374 and 376 are flat and rest on and are pressed against exterior side 218 of periphery 378 of mask opening 144 of shield 106. More specifically and as best shown in FIG. 9H, a nose relief portion 146 of periphery 378 of exterior side 218 of mask opening 144 of shield 106 presses against respirator side 342 of flanges 374 of seal member 112 as shown by phantom lines 382. Further, mouth relief portion 156 of periphery 378 of exterior side 218 of mask opening 144 of shield 106 presses against respirator side 342 of flanges 376 of seal member 112 as shown by phantom lines 384. With this arrangement, when respirator assembly 110 and shield 106 are interlocked, they securely hold seal member 112 in between, with seal member 112 pressed against respirator 120, providing airtight assembly.

As best illustrated in FIGS. 9E to 9H, respirator side 142 of seal member 112 is comprised of a sealing projection 386 that includes a top periphery edge 388 that is curved inwardly, with curved portion 390 adapted to provide a seal against the face of the user, around nose and mouth. As users inhale filtered air, the inwardly curved edge 388 flexes outwardly toward the face to provide a substantially vacuumed seal around the nose and mouth. Further, as users exhale, the majority of moist exhaled air (not all) remain within the confines of main chamber 212 due to the sealing nature of the seal member 112 around the nose and mouth. This way, the majority of moist exhaled air is prevented from fogging shield 106 or eyeglasses.

Height 392 (FIG. 9A) of sealing projection 386 is of sufficient length to provide a seal against the face of the user, around nose and mouth, while allowing for sufficient room for the nose and mouth to be accommodated within main chamber 212 of respirator 120.

Sealing projection 386 further includes a nose relief portion 394 that is adapted to ergonomically accommodate the nose while maintaining a seal around the nose. Nose relief portion 394 further includes a dip section 396 that functions as a noise bridge while providing proper seal. Further included is a chin relief portion 398 that is adapted to ergonomically accommodate the upper chin portion while maintaining seal around the mouth.

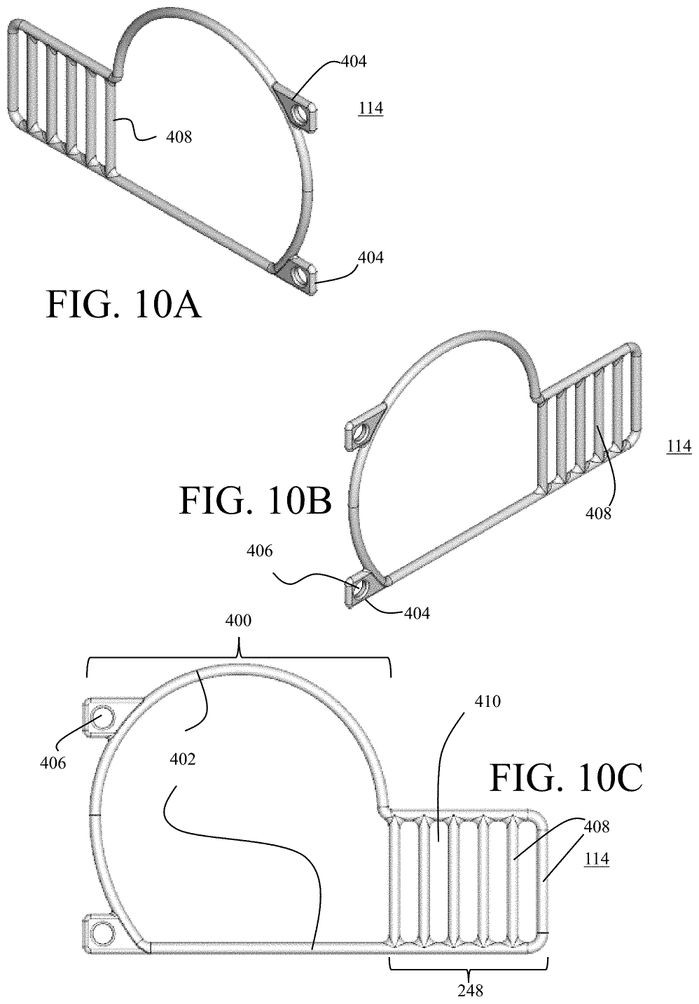

FIGS. 10A to 10C are non-limiting exemplary illustrations of an earpiece of PPE shown in FIGS. 1A to 9J in accordance with one or more embodiments of the present invention. As illustrated in FIGS. 1A to 10C, earpieces 114 include an ear lobe portion 400 comprised of a flexible, closed loop 402 adapted for mounting around the ear lobe.

Outer part of the ear lobe portion includes a connector 404 with an opening 406 that enables insertion of a head strap, thereby facilitating using the head strap to further secure the fully assembled EEP on a user's head.

Earpieces 114 further include an adjusting portion 248 for adjusting earpiece 114 for comfortable fit on the user. Adjusting portion 248 is comprised of a series of adjusting members 408 defining a series of adjuster opening 410, with an adjuster opening 410 of the series of adjuster openings receiving earpiece connector 244 of temple 152 of respirator 120, with a pair of adjusting member 408 that define the adjuster opening 410 secured within groove 246 of earpiece connector 244.

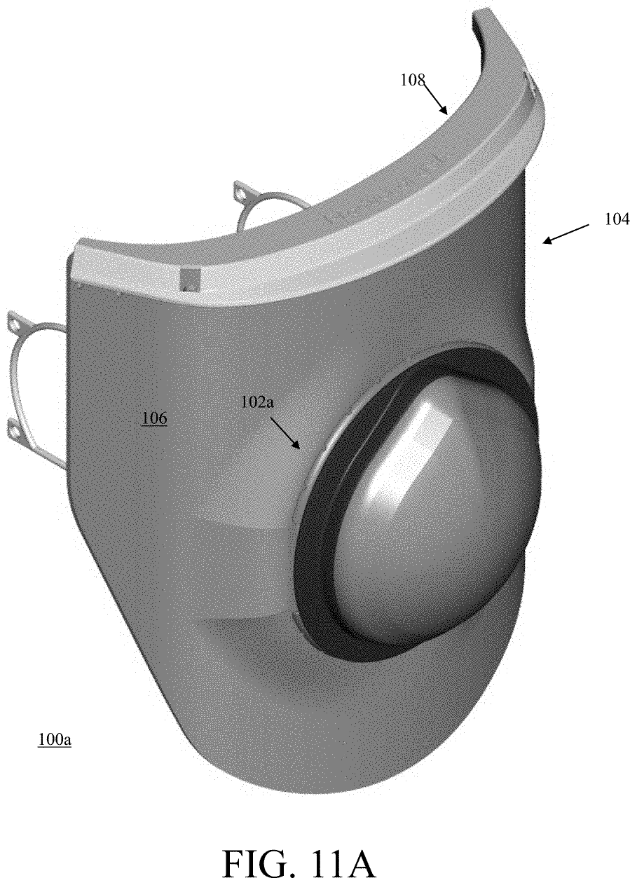

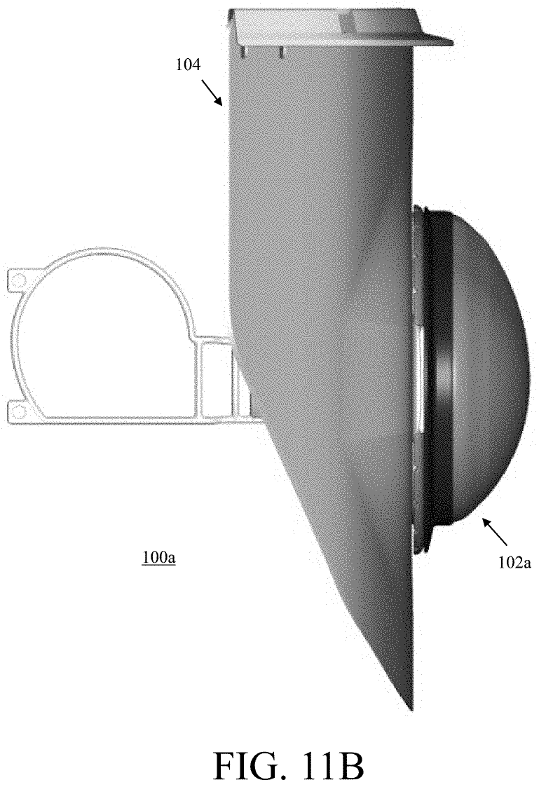

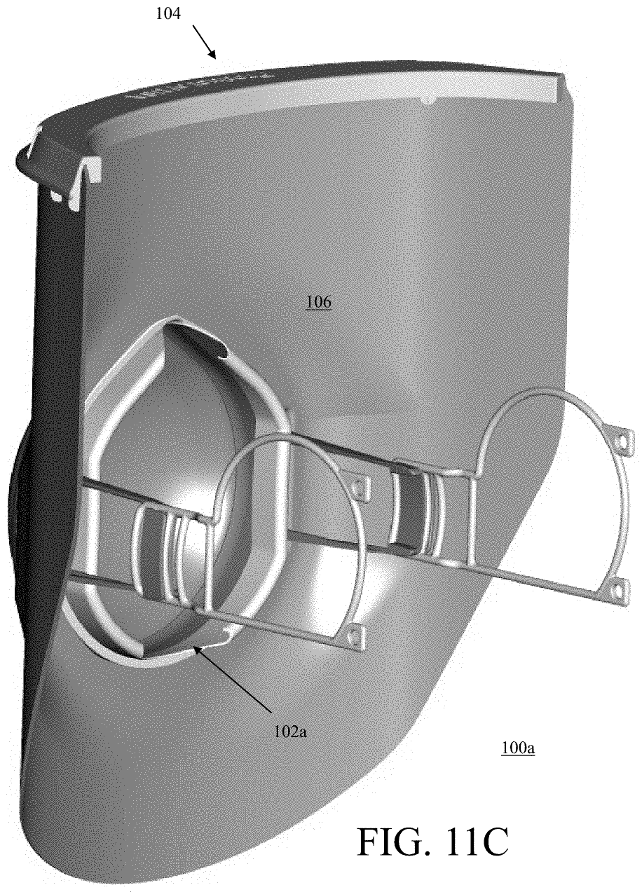

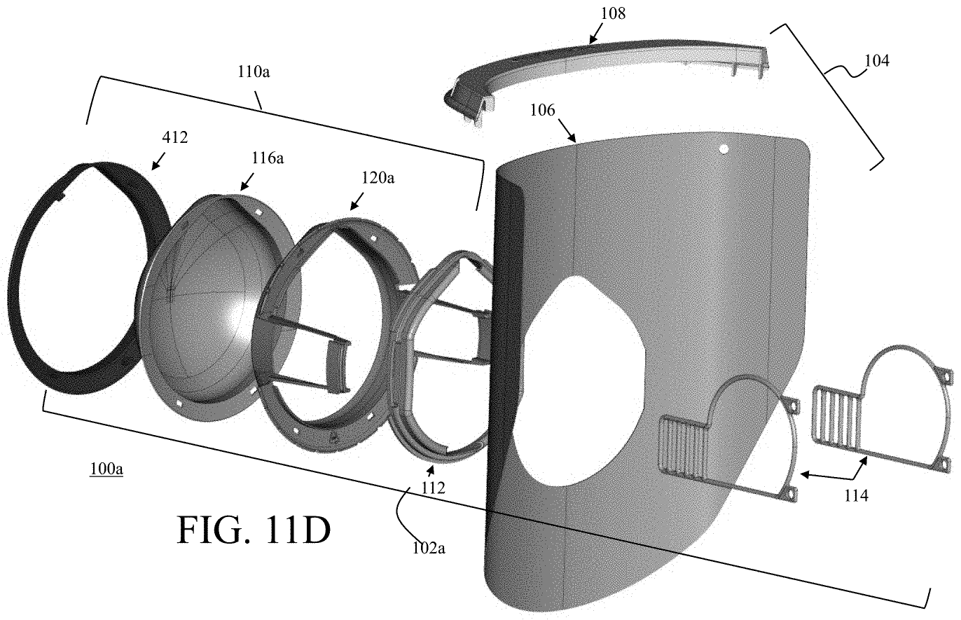

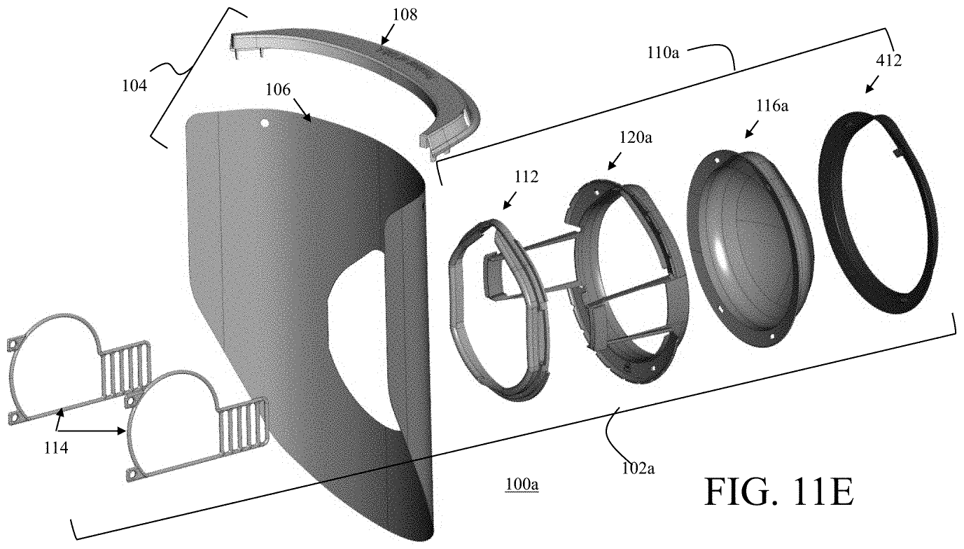

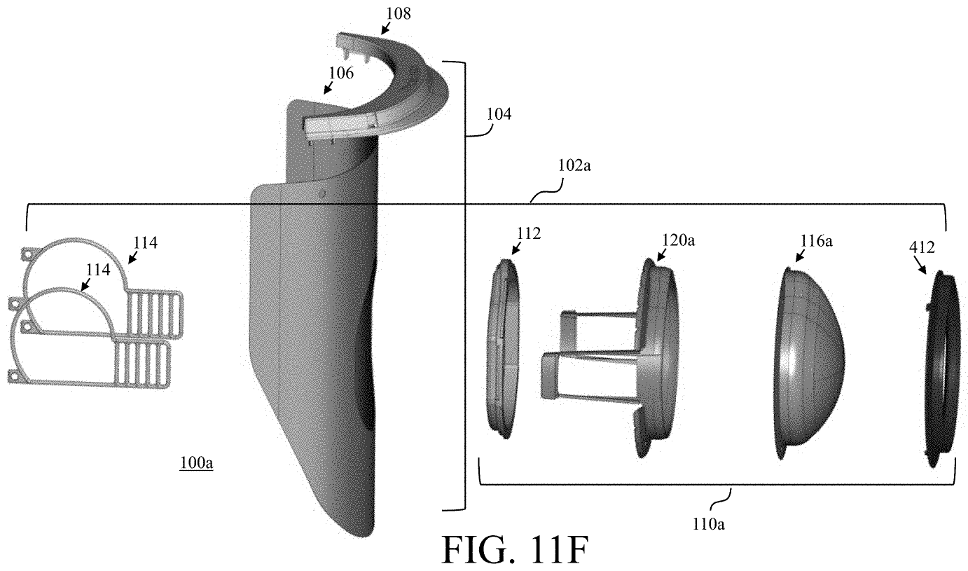

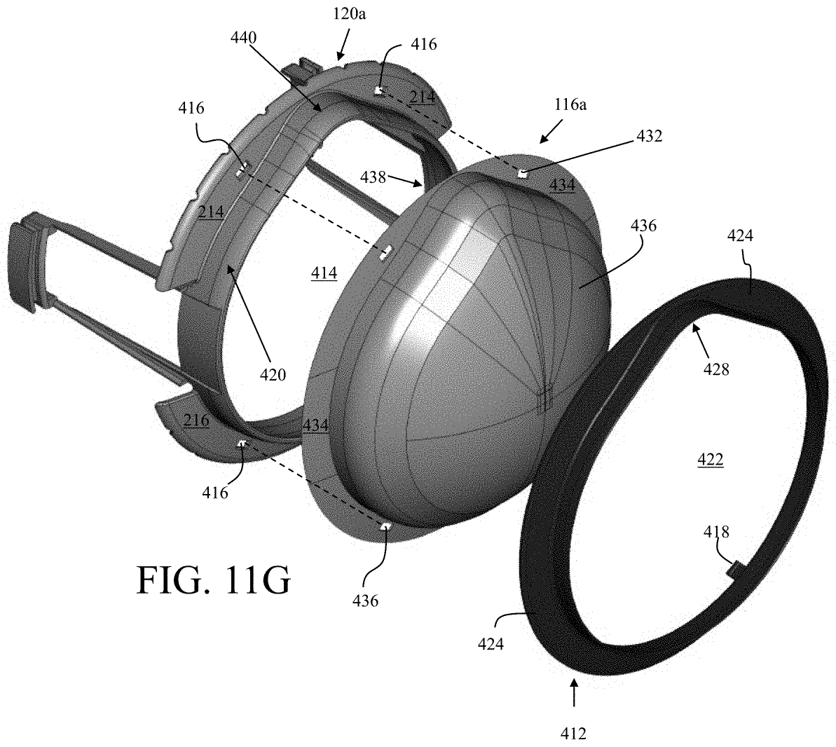

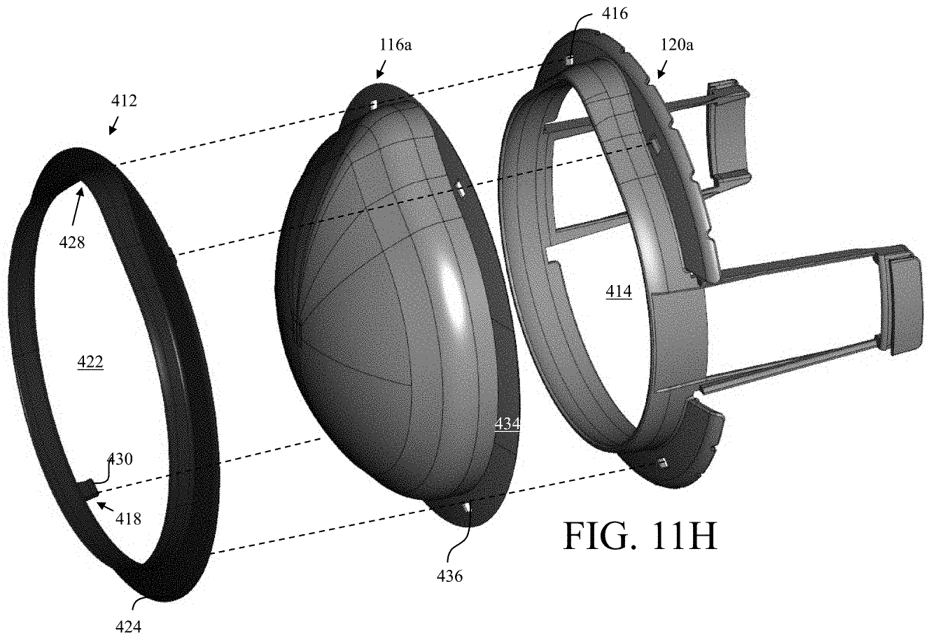

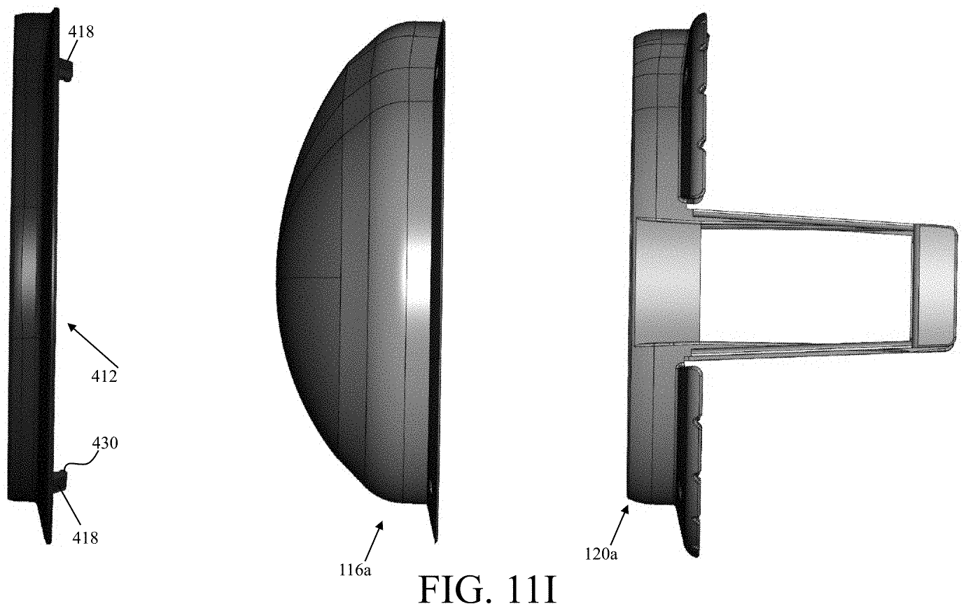

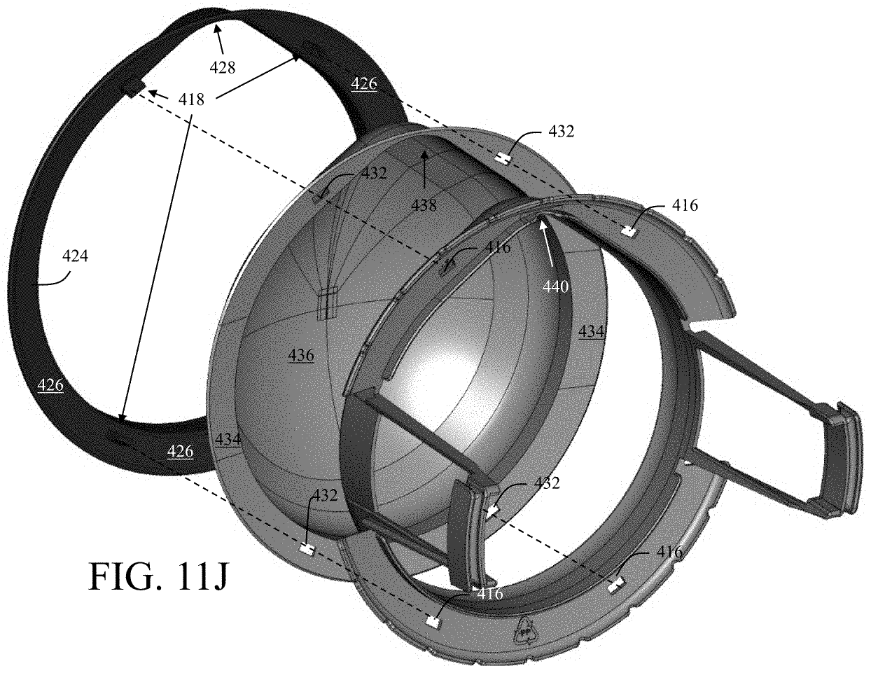

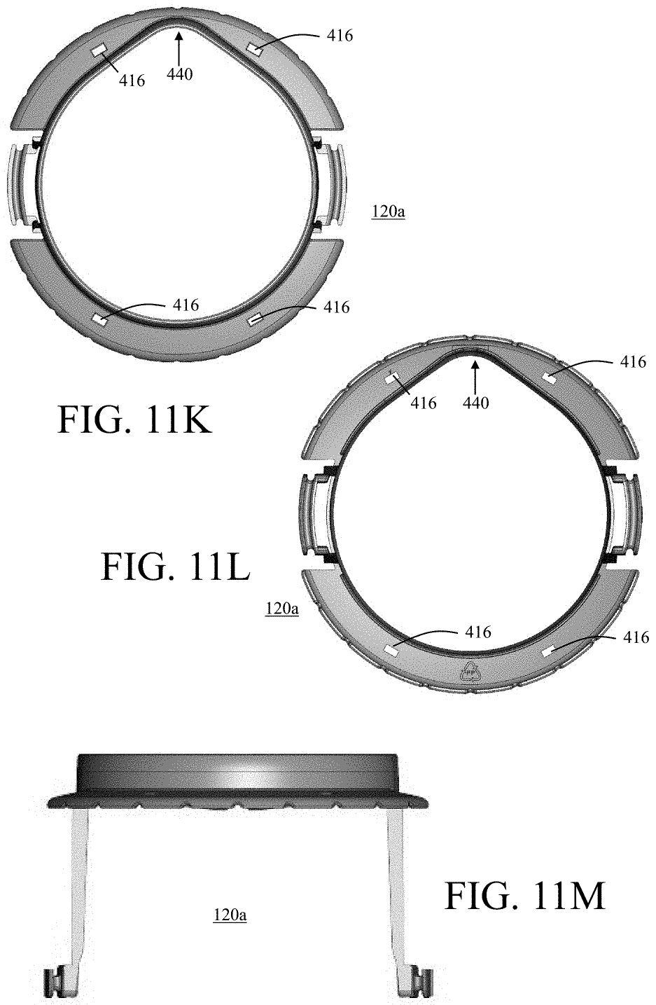

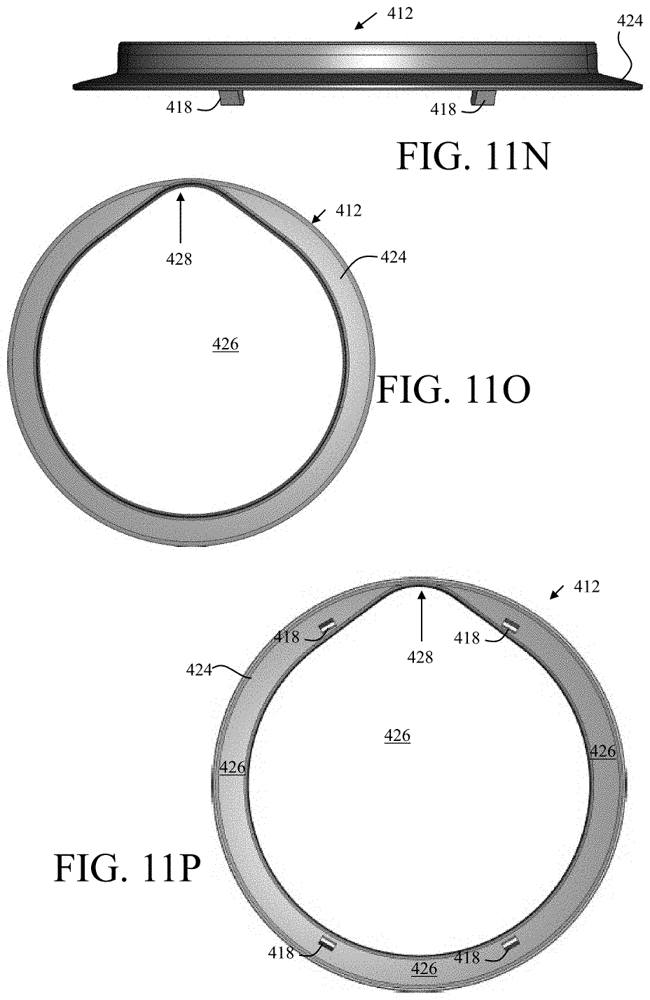

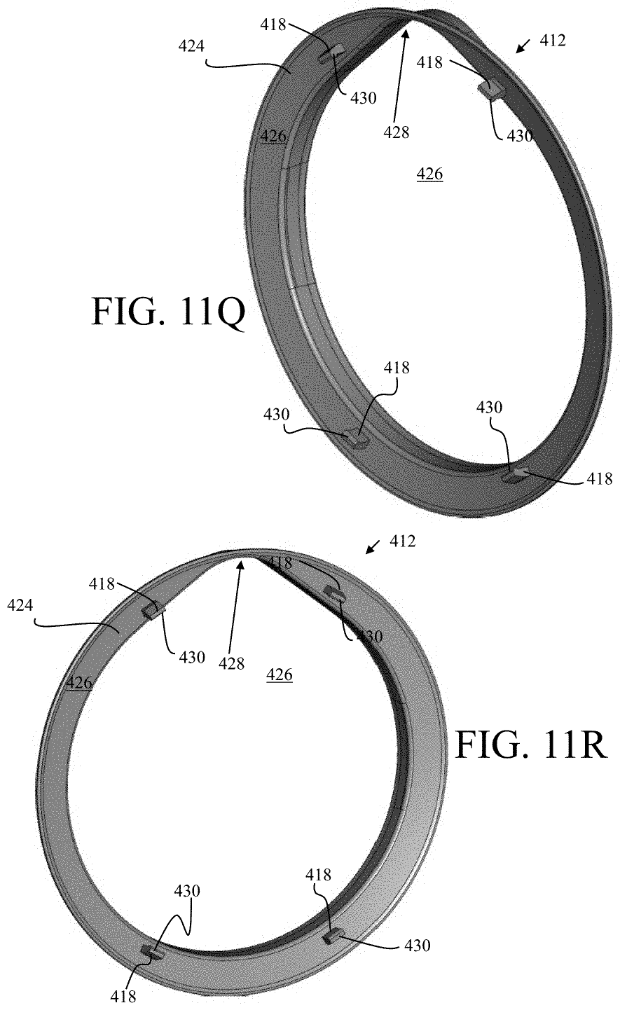

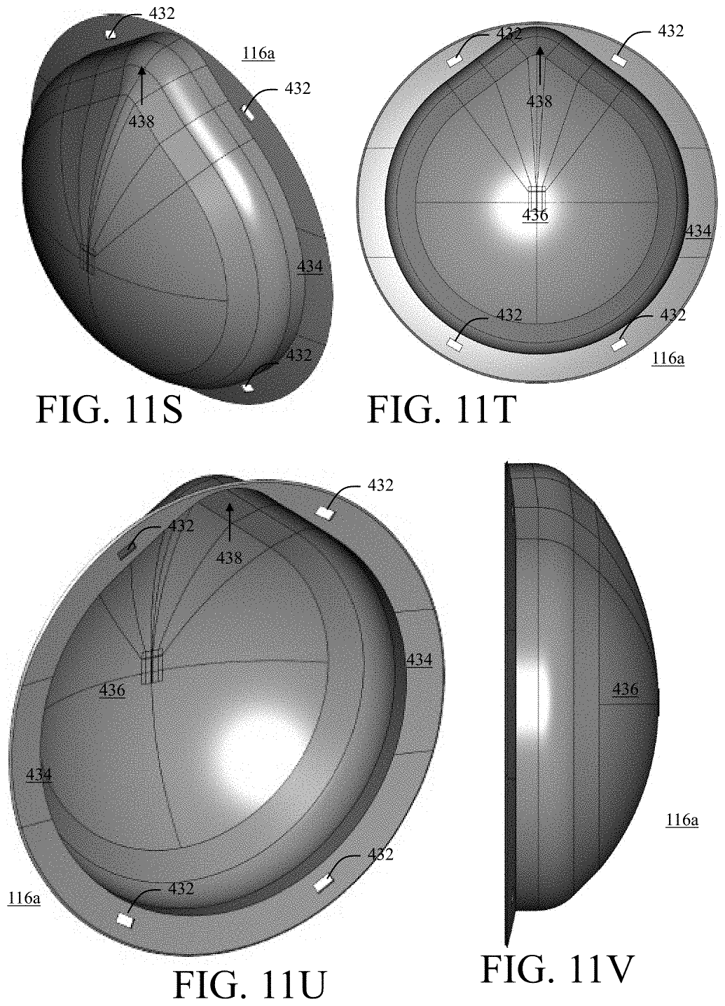

FIGS. 11A to 11V are non-limiting, exemplary illustrations of a PPE in accordance with an embodiment of the present invention, with interchangeable filter member. The PPE 100a illustrated in FIGS. 11A to 11V includes similar corresponding or equivalent components, methods, material, interconnections, functional, operational, and or cooperative relationships as the PPE 100 that is shown in FIGS. 1A to 10C, and described above. Therefore, for the sake of brevity, clarity, convenience, and to avoid duplication, the general description of FIGS. 11A to 11V will not repeat every corresponding or equivalent component, methods, material, interconnections, functional, operational, and or cooperative relationships that has already been described above in relation to PPE 100 that is shown in FIGS. 1A to 10C but instead, are incorporated by reference herein. As illustrated in FIGS. 1A to 11V, PPE 100a is comprised a detachably integrated mask 102a and face shield 104, with interchangeable filters 116a.

Mask 102a is comprised of respirator assembly 110a and a pair of earpieces 114. Respirator assembly 110a is comprised of a respirator 120a, a locking collar 412, a filter 116a, and seal member 112. Respirator 120a and locking collar 412 may comprise of medical grade plastic that may be cleaned and reused.

Respirator 120a is comprised of opening 414 configured and adapted to receive mouth and nose of a face of a user, which includes a nose relief portion 440 that functions as a nose bridge. Further included are locking openings 416 positioned on flanges 214 and 216 for receiving locking projections 418 of locking collar 412 to front-mount and secure filter 116a onto an exterior side 420 of respirator 120a.

Locking collar 412 includes a central opening 422 for accommodating filter 116a, and includes a nose relief portion 428 that functions as a nose bridge. Locking collar 412 has an annular flange 424, an interior side 426 of which includes locking projections 418. Locking projections 418 include engagement end 430 that pass filter locking openings 432 and friction fit (snap) into locking openings 416 respirator 120a.

Respirator assembly 110 further includes filter 116a is comprised of flange 434 with filter locking openings 432, filter body 436, and a nose relief portion 438. Filter locking openings 432 receive locking projections 418 of locking collar 412. Advantage of mask 102a is that any filter material may be used and configured to be connected with mask 102a. In other words, filter 116a is interchangeable.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Further, the specification is not confined to the disclosed embodiments. Therefore, while exemplary illustrative embodiments of the invention have been described, numerous variations and alternative embodiments will occur to those skilled in the art. ***For example, optionally, conventional molding techniques (e.g., injection molding) may be used to mold the seal member and or the earpieces and the respirator assembly, forming a single, integral piece. In other words, silicone members (e.g., seal and earpieces) may be directly injection molded in one step therefore being permanently attached with no assembly required. As another example, certain parts of the entire device (for example, the respirator) may be comprised of environmentally sustainable material, a non-limiting, non-exhaustive example of which may include corn derivatives molding resin. It should be noted that all filters used are clean and may be replaced. Such variations and alternate embodiments are contemplated, and can be made without departing from the spirit and scope of the invention.

It should further be noted that throughout the entire disclosure, the labels such as left, right, front, back, top, inside, outside, bottom, forward, reverse, clockwise, counter clockwise, up, down, or other similar terms such as upper, lower, aft, fore, vertical, horizontal, lateral, oblique, proximal, distal, parallel, perpendicular, transverse, longitudinal, etc. have been used for convenience purposes only and are not intended to imply any particular fixed direction, orientation, or position. Instead, they are used to reflect relative locations/positions and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

Further the terms “a” and “an” throughout the disclosure (and in particular, claims) do not denote a limitation of quantity, but rather denote the presence of at least one of the referenced item.

The use of the phrases “and or,” “and/or” throughout the specification (if any used) indicate an inclusive “or” where for example, A and or B should be interpreted as “A,” “B,” or both “A and B.”

In addition, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of,” “act of,” “operation of,” or “operational act of” in the claims herein is not intended to invoke the provisions of 35 U.S.C. 112, Paragraph 6.

What is claimed is:

1. Personal protective equipment, comprising:
a detachably integrated mask and face shield.

2. The personal protective equipment as set forth in claim 1, wherein:
the face shield is comprised of detachably integrated shield and headrest.

3. The personal protective equipment as set forth in claim 2, wherein:
the shield includes a mask opening.

4. The personal protective equipment as set forth in claim 3, wherein:
the mask opening is laterally symmetrical and is comprised of:
a nose relief portion,
interlocking lateral sides , and
a mouth relief portion.

5. The personal protective equipment as set forth in claim 1, wherein:
the mask is comprised of detachably integrated:
a respirator assembly; and
a pair of earpieces.

6. The personal protective equipment as set forth in claim 5, wherein:
the respirator assembly is comprised of detachably integrated:
a respirator;
a filter housing cover;
a filter; and
a seal member.

7. The personal protective equipment as set forth in claim 6, wherein:
the respirator includes:
a filter chamber having a bottom surface that includes a filter housing;
a main chamber ergonomically adapted to accommodate and cover over the mouth and nose; and
lateral temples.

8. The personal protective equipment as set forth in claim 7, wherein:
the filter housing is comprised of:
a set of openings at a base of the filter housing that function as vents.

9. The personal protective equipment as set forth in claim 8, wherein:
a filter positioned within the filter housing and covered over and secured by the filter housing cover.

10. The personal protective equipment as set forth in claim 6, wherein:
the filter housing cover includes:
inner perimeter walls for securing a filter;
outer perimeter walls for securing the filter housing cover to the filter housing; and
a filtered ventilation channel between the inner perimeter walls and the outer perimeter walls.

11. The personal protective equipment as set forth in claim 6, wherein:
seal member is positioned between an exterior surface of the shield and respiratory functioning as a gasket seal.

12. The personal protective equipment as set forth in claim 6, wherein:
the lateral templets are comprised of:
a pair of projections having base ends extending from a lateral side of the respirator via living hinges;
the pair of projections having a top end that converge and are connected to lateral sides of an earpiece connector;
the earpiece connector is comprised of a groove that receives an adjusting portion of an earpiece.

13. The personal protective equipment as set forth in claim 6, wherein:
the earpiece includes:
an ear lobe portion comprised of a flexible, closed loop adapted for mounting around the ear lobe; and
an adjusting portion for adjusting the earpiece for proper fit.

14. Personal protective equipment, comprising:
a detachably integrated mask and face shield, with interchangeable filters.

15. The personal protective equipment as set forth in claim 14, wherein:
the mask is comprised of detachably integrated:
respirator assembly; and
a pair of earpieces.

16. The personal protective equipment as set forth in claim 15 wherein:
the respirator assembly is comprised of:
a respirator;
a locking collar;
a filter; and
seal member.

17. The personal protective equipment as set forth in claim 16 wherein:
the respirator is comprised of main opening; and
locking openings positioned on flanges for receiving locking projections of the locking collar to front-mount and secure a filter onto an exterior side of respirator.

18. The personal protective equipment as set forth in claim 17 wherein:
locking collar includes a central opening for accommodating filter, flanges that include locking projections, and a nose relief portion that functions as a nose bridge;
locking projections include engagement parts that pass the filter locking openings and friction fit into the locking openings of the respirator.

19. The personal protective equipment as set forth in claim 17 wherein:
filter is comprised of flanges with filter locking openings and filter body, with filter locking openings receiving locking projections of the locking collar, and nose relief portion.

20. A method of assembly of a personal protective equipment, comprising:
positioning a headrest with the bottom side up;
bending and aligning a shield, with a top periphery edge of the shield aligned with a front recess slot of the headrest;
inserting the top periphery edge into the slot of the headrest to form a face shield;
mounting a detachably integrated mask within mask opening of the face shield; and
adjusting earpieces of mask for a comfort wear.
